(19) United States
(12) Patent Application Publication
(10) Pub. No.: US 2012/0315082 A1
(43) Pub. Date: Dec. 13, 2012

(54) Method of Forming A Coupling

(76) Inventor: Geoffrey Robert Linzell, Hatfield Herts (GB)

(21) Appl. No.: 13/579,476

(22) PCT Filed: Feb. 14, 2011
(86) PCT No.: PCT/GB2011/000194

§ 371 Date: Aug. 16, 2012

(30) Foreign Application Priority Data
Feb. 16, 2010 (GB) 1002620.1
Sep. 3, 2010 (GB) 1014651.2

(51) Int. Cl. B32B 37/10; B32B 9/00

(52) U.S. Cl. 403/270; 264/249

(57) ABSTRACT

There is provided a method of forming a coupling between a first body (71, 72) and a third body (76), which comprises selecting a first body having a first body layer and a third body having a third body layer; sandwiching a second body layer of a deformable body (74) between said first body layer and said third body layer; forming a first coupling between the third body layer and the second body layer; and forming a second coupling between the first body layer and the second body layer by providing a friction-enhancing fluid medium between the first body layer and the second body layer and without introducing relative sliding there-between pressing the second body layer against the first body layer such as to deform the second body layer into cold pressure welding contact with the first body layer.

### FIELD OF THE INVENTION

The invention provides a method of making mechanical couplings between bodies.

### BACKGROUND

Experience in applying the teachings of our earlier U.S. Pat. No. 5,348,210 has shown this to be a highly effective method of cold coupling metal parts with press fits whose frictional coupling strength is enhanced by the introduction of a friction-enhancing chemical at the sliding interface. However, it has become evident that in some applications there is a need for an improved method of making couplings, especially those between relatively thin wall co-axially arranged metal bodies to eliminate the risk of buckling and distortion due to very high sliding resistance experienced after introducing friction-enhancing fluid mediums. What is needed is a method of creating friction-enhanced couplings without sliding between friction-enhanced interfaces.

Thus the problem to be solved is to provide a method of making overlapping friction-enhanced couplings between parts without subjecting the parts to excessive buckling or bending forces due to the introduction of said friction-enhancing fluid mediums.

In solution, there is provided a method of forming a coupling between a first body and a third body, which comprises selecting a first body having a first body layer and a third body having a third body layer; sandwiching a second body layer of a deformable body between said first body layer and said third body layer; forming a first coupling between the third body layer and the second body layer; and forming a second coupling between the first body layer and the second body layer by providing a friction-enhancing fluid medium between the first body layer and the second body layer and without introducing relative sliding there-between pressing the second body layer against the first body layer such as to deform the second body layer into cold pressure welding contact with the first body layer.

In embodiments, the method provides means of coupling combinations of axially aligned abutting bodies in a first layer and securely couple said aligned bodies in applications ranging from coupling lengths of pipe or rods or make attachments onto a shaft or into a cylinder or form complex assemblies like crank shafts or couple and secure bodies with hollow pins that act like a dowel pin for coupling mechanical elements such as machine parts.

In embodiments, the method further provides means of coupling parts selected from the following material combinations: metal to metal, metal matrix composites to metal matrix composites, dissimilar metal parts, dissimilar metal matrix composites and combinations of metal and metal matrix parts; the composites including fibre or nano-particle reinforced metal or other reinforced materials employing a polymer matrix either coupled to like or dissimilar materials such as metals of metal matrix composites.

In embodiments, the method further provides couplings whose coupling characteristics are improved by selecting materials employed in the layers to have anisotropic properties, these selected to provide more stiffness and strength in either the axial or radial direction. For example it is beneficial to provide a coupling sleeve layer with maximum tensile strength with low elasticity in the axial direction while being highly elastic and easily deformable in the radial direction. Likewise the reverse characteristics are beneficial in the deformer/reaction layer where it is highly advantageous to have a very stiff radial feature. These characteristics are readily provided with reinforced composite materials, the use of which maximise strength while minimising bulk and added weight.

In practical applications such as in equipment operating in hazardous environments as encountered in oil fields or process plant the advantages of the method are that the join can be made cold, without the inconvenience or expense of providing welding or employing abutting flanges or parallel or tapered end threads. The join can be made releasable for servicing by relaxing the force pressing the friction enhanced faces together within the overlap of the coupling, with no need to apply heat or cut the tube, thereby avoiding the risk of ignition of volatile residues. In embodiments, the method further provides means of coupling thread-less lightweight high strength releasable couplings are provided employing reinforced metal matrix composites suitable for coupling drill string sections.

U.S. Pat. No. 7,452,156 describes means of producing composite structural members employing composite tubular bodies retained in a sandwich like construction. This provides significant axial strength derived from radial mechanical interlocking but relies on epoxy adhesives, dry friction or distorting the circular construction shown to provide reliable torsional coupling which is undesirable. The subject method differs over these disclosures by introducing friction-enhancing fluid mediums between parallel faces that can provide parent material strength coupling in torsion and tension. In embodiments, subject method also differs by providing means of coupling bodies with unimpeded sealed flow bores. In embodiments, subject method also differs by beneficially exploiting composites with anisotropic characteristics.

U.S. Pat. No. 5,183,358 disclose an expandable fixture pin that relies upon natural friction at its gripping interface and tapers to expand the pin, whereas the subject method employs a frictionally enhancing chemical at its interface and therefore can develop sufficient grip at a lower contact pressure.

US 2005/0281631 discloses a locking pin system with a screw operating a tapered cam expanding a tapered sleeve for clamping a fixture plate onto a receiving plate. It does not disclose the use of friction-enhancing chemicals.

Friction-enhanced thread-less lap joins between steel tubular bodies (TB's hereinafter) are described in our earlier application U.S. Pat. No. 5,348,210.

WO 2005/071212 describes a friction retained plastically expanded join between smooth overlapping metal sections of tubular bodies or connectors. This describes means of making plastically expanded joins employing the chemical friction-enhancement taught in our earlier patent mentioned above, in which all the components within the join, including the coupled tubulars are all subjected to significant plastic expansion and cannot therefore be released, whereas in the method body layer materials are only elastically deformed save for the tips of contacting asperities between pressed together layers, thus upon relaxing the pressing force the bodies elastically contract allowing the coupling to be disassembled.

U.S. Pat. No. 5,181,752 describes frictional lap joins employing ring indentations of the joined body by a suitably formed coupling. This method employs one or more shallow ridges that are forced into the outer surface of the tube to deform the tube and form a shallow mechanical interlock. U.S. Pat. No. 7,011,344 describes frictional lap joins employing roughened or patterned interlocking elements that are held trapped between the joined metal tubular metal bodies or a pipe connector body.

US 2009/0101328 describes means of joining a drill string employing composite drill pipe joined with tapered threaded metal couplings.

U.S. Pat. No. 4,093,052 disclose a fluid actuated coupling assembly that is used as and expandable layer within a sandwich construction as taught with the method.

In summary the invention distinguishes over all the above by providing a method for making lightweight releasable high friction couplings between smooth parallel surfaces, between bodies arranged in co-axial layers thereby forming a sandwich in which the middle body layer of the sandwich is more deformable than the outer layers; the middle body layer having a friction-enhancing fluid medium at its interface with at least one body layer of the sandwich. The friction enhancing fluid medium chemically interacting at contacting asperities between pressed together smooth surfaces to enhance asperity cold pressure welds preventing lateral sliding, upon relaxing pressing force said cold pressure welds fracture to facilitate disassembly of coupling.

### SUMMARY OF THE INVENTION

According to one aspect of the present invention there is provided a method of forming a coupling between a first body and a third body, the method comprising

I. selecting a first body having a first body layer and a third body having a third body layer;

II. sandwiching a deformable second body layer of a second body between said first body layer and said third body layer;

III. forming a first coupling between the third body layer and the second body layer; and

IV. forming a second coupling between the first body layer and the second body layer by providing a friction-enhancing fluid medium between the first body layer and the second body layer and without introducing relative sliding there-between pressing the second body layer against the first body layer such as to deform the second body layer into cold pressure welding contact with the first body layer.

The present invention also provides a coupling obtainable by the method described herein.

There is provided a method of forming a coupling between a first body and a third body. The term coupling is used to distinguish over the term join which implies fusion of materials as occurs in permanent welding or the introduction of adhesive that forms irreversible chemical bonds, therefore true joins are essentially not reversible. A ‘coupling’ is defined in the Oxford English Dictionary as a link or device for connecting parts of machinery and ‘coupling’ is used hereinafter to define a device that links, extending to the components comprising the actual linkage provided between several touching mechanical parts.

Therefore the term coupling as used hereinafter means the linking of two or more mechanical parts, otherwise referred to as bodies. In embodiments, said touching bodies have features that facilitate them being positioned one with respect to others with areas touching in overlapping relationship and sharing a common axis, referred to as co-axial. Thus in relation to this method the meaning of the term ‘coupling’ may include the action of bringing together and applying pressure by pressing them together and holding together two surfaces exhibiting high resistance to sliding one against the other, said resistance is termed friction, said friction provides linkage between the pressed together faces. The level of magnitude of said friction being dependent upon the pressure applied between pressed together faces, the material characteristics, and the presence of introduced materials as well as interlocking roughness. Thus the friction experienced between the faces provides useful coupling to facilitate transmitting mechanical forces applied to one body into another body.

In embodiments, the term ‘coupling’ is used herein to describe the linking of a first body to a third body via an intermediate second deformable body that is in touching contact between the first and third bodies to provide a construct resembling a sandwich with three touching (e.g. parallel) layers, each layer with one or more bodies, hereinafter referred to as a body layers.

The method involves selecting a first body having a first body layer and a third body having a third body layer; first and third body layer material selected to provide sufficient strength in their overlapping features for the purpose of forming a pre defined mechanical coupling. The body layers can contain more than one body arranged in an abutting relationship again sharing a common axis.

The method further comprises sandwiching a deformable (or in embodiments, ductile) second body layer of a second body between said first body layer and said third body layer. In embodiments, the second body as a whole is deformable (or in embodiments, ductile). In embodiments, the second body or body layer material is selected, sized and shaped to be more deformable than the first and third body layer materials. All materials are selected to be capable of providing sufficient strength within their overlapping features for the purpose of forming the desired mechanical coupling.

Said (e.g. co-axial) sandwich can be configured with the bodies in the first body layer arranged/positioned on either the outside or inside of the bodies of the second body layer and details of the range of potential configurations are defined hereinafter with reference to diagrams. In embodiments, the body layers comprising the sandwich are in embodiments, initially sized to provide a clearance fit between the first body layer and second body layer and an interfering fit between the second body layer and the third body layer.

The method involves forming a first coupling between the third body layer and the second body layer.

The method involves forming a second coupling between the first body layer and the second body layer by providing a friction-enhancing fluid medium between the first body layer and the second body layer and pressing the second body layer against the first body layer such as to deform the second body layer into cold pressure welding contact with the first body layer. Said pressing against is required to occur without introducing relative sliding between the first and second body layers and preferably involves that no relative lateral motion is present between these body layers.

In embodiments, the step of pressing the second body layer against the first body layer is mechanical and involves forcibly sliding the third body layer against the second body layer. Thus, in embodiments, compressive pressure is applied by forcibly sliding the third body layer against the second body layer such as to radially deform the second body layer into high pressure contact, thereby creating and maintaining a frictional contact with the first body.

In embodiments, the surfaces of the pressed together faces are suitably prepared and treated to develop high levels of friction to resist sliding. The actual preparation of the forced together faces is influenced by the materials and condition of the bodies of the first and second layers. For example, in the case of metals they may vary from being apparently smooth to the eye yet have microscopic roughness that facilitate cold pressure welding at asperity contacts, each weld is formed within its own localised compressive stress field and the sum of said localised stress fields are maintained in compression by the aforementioned deforming pressure holding the second body pressed against the first body. These welds spontaneously crack upon relaxation of the compressive stress due to elastic relaxation, which facilitates disassembly.

In other embodiments, the overlapping surfaces may be significantly rough so as to form mechanical interlocks and resist sliding when the material combinations are otherwise chemically or metallurgically incompatible such as when coupling metals to non-metals and more guidance is provided on these matters by reference to examples later herein.

In embodiments, the step of pressing the second body layer against the first body layer involves expanding the second body layer or expanding the third body layer against the second body layer.

In embodiments, the step of pressing the second body layer against the first body layer involves hydraulically or hydro-mechanically expanding the second body layer or hydraulically or hydro-mechanically expanding the third body layer against the second body layer. In embodiments, the step of pressing the second body layer against the first body layer is by means of sliding taper expanding of the second body layer or sliding taper expanding of the third body layer against the second body layer.

In embodiments, the step of pressing the second body layer against the first body layer involves elastic deformation as means for pressing the surfaces together. In embodiments, the step of pressing the second body layer against the first body layer involves mechanical means (e.g. a cam like action) as means for pressing the surfaces together. In embodiments, the step of pressing the second body layer against the first body layer involves mechanical means (e.g. a hydro-mechanical action).

In embodiments the deformation required to press the second body layer against the first body layer is affected by either mechanical or hydro-mechanical means. After pre-positioning the coupled together parts in their precise final lateral relationship, pressure is for example applied to the second body by mechanical means by forcibly sliding an outer lubricated interfering body onto a deformable centrally sandwiched coupling sleeve or by sliding a pair of inserted tapered bodies one against the other to press against a deformable centrally sandwiched coupling sleeve, the coupling sleeve thereby deformed onto the part or parts being coupled with friction enhancing medium entrapped therebetween. In embodiments, the hydro-mechanical means are provided by a fluid activated coupling assembly comprising a tubular body with an enclosed chamber incorporated within its walls that is filled with hydraulic medium. Upon pressurising the medium the walls swell and apply pressure to deform adjacent overlapping bodies into their required frictional relationship.

There is provided a friction-enhancing fluid medium between the first body layer and the second body layer. The friction-enhancing fluid medium is suitably selected to chemically, metallurgically or mechanically, or some combination thereof, to interact with and form a frictional coupling for the purpose of resisting sliding between first body layer and the second body layer when they are pressed together. An example of a chemical interaction causing an increase in sliding friction is the softening of a polymeric matrix binder to facilitate local near surface flow thereby forming intimate interlocking coupling between the first body layer and the second body layer. An example of metallurgical interaction between pressed together surfaces is provided by a chemical substance that stimulates asperity welding upon contact between metallic faces upon forcible engagement (being pressed firmly together), thereby to resists sliding. Examples of such materials are certain low film strength siloxanes that exhibit pronounced anti-lubrication behaviour when trapped between certain metals. An example of mechanical interaction is provided by the introduction of chemically inert fine hard particles between the pressed together surfaces that cut into and form microscopic interlocks to resist sliding; or if the surfaces have similar hardness and roughness patterns then mechanical interlocking will occur as they are pressed and held together; or if one surface is made harder and rougher than the other then the hard surface will deform the soft surface and form mechanical interlocks that resists sliding.

In embodiments, a thin film of friction-enhancing fluid medium is employed.

In embodiments, the friction-enhancing fluid medium is selected from the group consisting of or CCU, a hydrocarbon solvent or a siloxane such as hydrogendimethylsiloxane.

In embodiments, the first coupling between the third body layer and the second body layer is a low friction coupling. In embodiments, the surfaces between the third body layer and second body layer are smooth to facilitate sliding said body layers together to form a low friction coupling between said body layers, either sliding over or into depending upon the configuration selected to suit the application. In embodiments, the method further provides means of releasing the coupling by sliding the third low friction layer off or out depending upon which way the layers are arranged.

In embodiments, additionally there is provided a friction-reducing agent between the third body layer and the second body layer to facilitate the forming of a low friction first coupling. In embodiments, said friction reducing agent is a lubricant that may be either wet or dry. An example of a wet lubricant is a fluid chosen to be chemically compatible with materials of the sliding face and able to reduce friction resistance to sliding, an example of which would be a mineral or vegetable oil with additives, typical of hydrocarbons prepared for use between metals or a synthesized liquid polymer commonly referred to as a synthetic lubricant which is suitable for use either on metallic or non-metallic surfaces. An example of a suitable dry lubricant for attachment to metal surfaces being a sacrificial material, such as graphite or molybdenum disulfide chemically attached to either or both the sliding faces of the second or third bodies. Where there is risk of galling during sliding, such as between stainless steels, one or both of the sliding pair may have a thin layer of non-galling material introduced such as copper providing the dissimilar metal combination does not cause unacceptable corrosion.

In embodiments, the method involves forming overlapping couplings employing three essentially parallel layers in a sandwich like construction between co-axially arranged (e.g. tubular) parts in which the centre layer is (e.g. radially) deformable and has one face treated with a friction-enhancing fluid medium and its other face treated with a friction reducing agent. The sandwich is arranged with a first member facing the friction-enhanced face and sized to be a clearance fit to facilitate it being slid into position without activating the friction-enhancer. The third sandwich layer faces the lubricated face and is sized to be an interference fit with the deforming centre layer so that upon sliding the third layer past (over or through) the centre layer the centre layer is radially deformed and pressed against and held in high friction gripping contact with the first layer, thereby forming a high friction coupling.

In embodiments, on pressing the second body layer against the first body layer neither body layer is subject to bulk plastic deformation thereof.

In embodiments, the second coupling between the first body layer and the second body layer is a releasable coupling.

In embodiments, the first body layer has a first smooth surface with micro roughness and said second body layer has a second smooth surface with micro roughness. Thus, inter-micro roughness space is defined by the micro roughness of said first body layer surface and that of said second body layer surface. In embodiments, the friction-enhancing fluid medium is provided to said inter-micro roughness space of at least one of the first and second body layer surfaces.

In embodiments, step IV of the method comprises:

(i) positioning the first body layer and the second body layer such that a first surface with micro roughness of the first body is brought into near contacting relationship with a second surface with micro roughness of the second body, wherein space is defined between the micro roughness of the first and second surfaces;
(ii) introducing a friction-enhancing fluid medium to said space between said first and second body surfaces;
(iii) moving said first body towards said second body to thereby deform the micro roughness of the first surface and/or second surface, thereby reducing the space between the first and second body surfaces and consequently (a) expelling a first part of said friction-enhancing fluid medium and (b) defining trap space between the first and second body surfaces for trapping a second part of said friction-enhancing fluid medium; and
(iv) further moving said first body relative to said second body to thereby further deform the micro roughness of the first surface and/or second surface in the presence of said second part of the friction-enhancing fluid medium within said trap space, to thereby form the cold pressure welding contact.

This embodiment provides a suitable way of applying a fluid friction-enhancing fluid medium and then bringing the coupled surfaces into and maintaining them in frictional contact between pressed together surfaces with micro roughness.

The embodiment involves positioning said first body and said second body such that a first surface with micro roughness of the first body is brought into near contacting relationship with a second surface with micro roughness of the second body, wherein space is defined between the micro roughness of the first and second surfaces. In embodiments, this step involves laterally positioning the first body and the second body.

It will be appreciated that all practical engineering surfaces have some roughness especially machined metal surfaces, the roughness being determined largely by the tools, speeds and feeds used to shape the surface.

By way of a guide fine turning will provide Ra ranging down to 2 micron, grinding to less than 1 micron and lapping and polishing to 0.1 micron or less. Ra is an industry standard amplitude parameter that characterizes the surface based on the vertical deviations of the roughness profile from a mean line. The term micro-roughness is used herein to describe relatively smooth surfaces measuring in the range typically Ra 0.2 to Ra 2.5 micron. These figures measured across the cut marks, which is the worst case. The initial clearance gap variation (machining tolerance) between a coupling and shaft is specified by ISO standards as—shaft H7 and friction coupling bore g6, which parameters define the clearance space between the micro roughness of the first and second surfaces into which friction-enhancing fluid is applied.

The surface micro-roughness preferably has an Ra value of from 0.2 to 2.5 micron, more preferably from 0.4 to 0.8 micron.

Specifically the term micro-roughness is used herein to describe the characteristic roughness of a surface suitable for pressing together to form the cold pressure welds by the method. Suitable surfaces may be economically prepared on equipments like a precision lathe, turning centre, milling centres or deep boring machines, each employing single point radiused cutters. With such machines the lower the feed rate and the larger the tool radius, the smoother the surface. The feed rate is the lateral progression or displacement of the cutter tip for each revolution of the work piece. Such single point cutting leaves a regular thread like profile on the surface, which is commonly described as a textured surface because of is consistency and repeatability. A suitable micro-roughness profile for use with the method is provided by way of an example and diagrams later herein.

The embodiment also involves introducing a friction-enhancing fluid medium to said space between said first and second body surfaces. The means by which said fluid is applied will depend upon the shape and size of the parts being coupled. In a typical case employing an hydraulically expandable coupling inserted between a shaft and pully there will be two friction interfaces, the first is the inner interface between the shaft and coupling bore and the second interface is between the coupling outter surface and the bore of the pully. A convienient way of regulating the application of friction enhancing fluid is to use a pad dispensing applicator (fully described in our patent application EP2023767) which dispenses mildly abrasive pads carrying predetermined amounts of friction enhancing fluid, that upon rubbing a first or second face of a friction interface cleans the metal by virture of its mildy abrasive nature while transfering a film of friction enhancing fluid onto the cleaned surface. It is only nessesary to apply said fluid film to one surface in each interface and the most convenient to treat are usually the first outter facing surfaces on the first body layer. However the mateing inner second surfaces should be cleaned with a dry mildly abrasive pad similar to a ScotchBrite green grade, both the application of the film and the cleaning of the bores should be done immediately before positioning the parts being coupled and moving the surfaces in the two friction interfaces into initial frictional contact.

The embodiment further involves moving said first body towards said second body to thereby deform the micro roughness of the first surface and/or second surface, thereby reducing the space between the first and second body surfaces and consequently (a) expelling a first part of said friction-enhancing fluid medium and (b) defining trap space (e.g. trap spaces) between the first and second body surfaces for trapping a second part of said friction-enhancing fluid medium. In practice, it is generally the high spots (asperities) on the first and second surfaces that deform as they are brought into contact.

The embodiment also involves further moving said first body relative to said second body to thereby further deform the micro roughness of the first surface and/or second surface in the presence of said second part of the friction-enhancing fluid medium within said trap space (e.g. trap spaces), to thereby form said friction coupling. In embodiments, no relative lateral motion is present during this step.

In the forming of the layered coupling by the method one body layer deforms another body layer to drive the deformed layer into yet another layer. If as a result unwanted axial extrusion occurs in the deformable second body layer it is alleviated by introducing small grooves into the friction interface of the second body layer to provide somewhere for extruding material to flow, this minimises overall distortion as the coupling is formed and ensures there is zero net lateral displacement at the friction interface as the friction enhanced interface is formed. The introduction of said groves further provides means of modulating the residual stress between the deformed body and the deforming body. In embodiments, the deforming of the second body layer can vary along the axis of overlap with the third body layer.

In embodiments, contact pressure is progressively applied, either by forcing an interfering ring into position, operating a sealed screw in an expandable hydraulic layer or sliding opposing tapered members causing the sandwiched coupling to deform and expel a first part of said friction enhancing medium, bringing the surfaces into contact with a motion normal to said friction inter faces such that a proportion of the high spots (asperities) on the first and second surfaces in both friction interfaces come into contact defining trap space between the first and second faces in both friction interfaces, thereby trapping a second part of said friction-enhancing fluid medium. As said applied pressure continues to rise the material in and about each deforming asperity contact progressively deforms equilaterally resulting in zero net lateral displacement and motion between the first surface on the first body or the second surface on the second body, the amount of equilateral asperity material deformation being increased by the action of the friction enhancing fluid thereby forming larger contacts with exposed virgin clean reactive metals to facilitate cold pressure welding thereby enhancing the friction coupling between the pressed together surfaces. Thus, further pressing of the first body later against the second body layer thereby further deforms the micro roughness of the first surface and/or second surface in the presence of said second part of the friction-enhancing fluid medium within said trap space, to thereby form the cold pressure welding contact.

In embodiments, the forming step IV involves:

(i) positioning the first body layer and the second body layer such that the first body layer surface is brought into near or light contacting relationship with the second body layer surface;
(ii) applying pressing force to press the second body layer against the first body layer to deform the micro roughness of the first body layer surface and/or second layer body surface and to thereby
(A) reduce the inter-micro roughness space between the micro roughness of the first body layer surface and/or second body layer surface and consequently to (a) expel a first part of said friction-enhancing fluid medium and (b) define trap space between the first and second body layer surfaces for trapping a second part of said friction-enhancing fluid medium; and
(B) form cold pressure welds at asperity contacts between the first body layer surface and second body layer surface in the presence of said second part of the friction-enhancing fluid medium within said trap space, such as to form said cold pressure welding contact, wherein the coupling between said first body layer and second body layer is maintained by said pressing force and upon removal of the pressing force, said cold pressure welding contact fractures to allow for release of the second coupling.

In embodiments, the method of forming a coupling herein may be employed to make a reversible friction union between two parts by pressing parallel faces on the parts together thereby placing the faces under compressive stress and maintaining said stress, the union being undoable by relaxing or removing said stress.

In embodiments, the first coupling between the third body layer and the second body layer is made by providing a friction-enhancing fluid medium between the third body layer and the second body layer and without introducing relative sliding therebetween pressing the second body layer against the third body layer such as to deform the second and third body layers into cold pressure welding contact with each other. Said pressing against is required to occur without introducing relative sliding between the second and third body layers and preferably involves that no relative lateral motion is present between these body layers. Thus, in this embodiment both the first and second body layers and the second and third body layers are in cold welding contact with each other.

In embodiments, any of the first, second or third bodies are tubular in form. In embodiments, any body that is not tubular has a bore that is similar to that of a tube being round and straight but its wall thickness may vary. An example of such a first body layer that is not tubular is provided when the method is used to locate and couple together structural bodies in the form of precision mechanical elements such as used in machine tools where extensive use is made of dowels to locate and retain parts. In embodiments, the method provides useful means of coupling such machine tool elements, the elements constituting the first body layer, an expandable high grip dowel pin comprises the second body layer and the coupling is formed by driving in the relatively low friction third body layer, as illustrated later herein.

In embodiments, all of the first, second and third bodies are tubular in form. These configurations are typically used for coupling together tubular or rod like bodies illustrated later herein where the method is used to couple together thin wall tubular bodies by the method.

In embodiments, any one of the first, second or third body layers is comprised of an abutting arrangement of a first tubular body part with a second tubular body part and the coupling acts to couple together said first tubular body part to said second tubular body part. In embodiments, the abutting faces are prepared square (normal) to the axis of the bodies so that upon abutting, the ends of the coupled together bodies become precisely aligned along a common axis, while the bodies within coupling are co-axial in the radial plane.

In embodiments, each of the first and second tubular body parts defines a tubular end portion shaped to define a mutually abutting, preferably mutually sealing relationship. In embodiments, if the end faces of two parts are machined flat and normal to the axis, and then pressed and held together this provides a seal to prevent materials within a flow bore escaping or the ingress of material into the flow bore. Furthermore the seal integrity can be improved by adding a sealing ring of suitably deformable material inserted between said abutting end faces so that the end faces abut against the seal or if space permits the seal may be partly recessed into each abutting end face and compressed then held compressed by the action of forming the coupling. The deformable materials selected for the sealing ring can vary from polymeric, such as blends or natural and synthetic rubber to ductile high modulus metals.

In embodiments, each of the tubular end portions of the first and second body parts defines a smooth planar end face for defining a face-to-face abutting, preferably pressure sealing relationship therebetween. In embodiments, the pressure sealing enhanced by the provision of a deformable metal seal placed therebetween.

In embodiments, the first body is comprised of an abutting arrangement of a first non-tubular body part with a second non-tubular body part and the coupling acts to couple together said first non-tubular body part to said second non-tubular body part. This is typically for the purpose of providing a precision location and structurally strong mechanical coupling.

In embodiments, the second and third bodies are tubular in form such as in combination to define a hollow coupling pin for locating and retaining the first and second non-tubular body parts in coupled relationship. In embodiments, the hollow coupling pin thereby acts as an expandable hollow dowel pin with a through bore.

In embodiments, the second body is tubular in form and the third body has solid cylindrical form such as in combination to define a solid coupling pin for locating and retaining the first and second non-tubular body parts in coupled relationship.

In embodiments, the method herein extends to a means of coupling threaded end terminals onto tubular bodies (that are themselves parts of so called “threaded couplings”). In embodiments, the second tubular body defines a tubular end portion having an end face and first tubular body has a radially cut-away end portion having an end lip, wherein said radially cut-away portion is arranged for receipt of said tubular end portion such that said end face is brought into abutting relationship with said end lip. One application for this type of coupling construction is for attaching metal threaded connectors onto non-metal tubular bodies, especially those made with composites for use in lightweight drill strings.

In embodiments, a seal between the aforementioned threaded couplings is provided, wherein each of the tubular end portion and the end lip defines a smooth planar end face arranged for face-to-face abutting relationship. In a still further embodiment, a deformable ‘0’ ring like seal is added between the face to face abutting tubular ends.

In embodiments, any of the first, second and third body layers and/or bodies is comprised of materials selected from the group consisting of metals, reinforced metal taking the form of metal matrix composites (MMC), non-metal composites such as carbon composites, plastic polymers, fibre or nano-particle reinforced matrices of ductile metal or polymers and combination thereof.

The matrix (base material) of these composites selected to have compatible high friction characteristics when pressed against the tubulars being joined and minimum corrosion risk. MMC's are monolithic metal bodies such as aluminums and steels reinforced with fine fibers or particulates, for example in the case of an aluminum matrix (body) the reinforcement materials may be selected from but not limited to the range

Continuous fibers: boron, silicon carbide, alumina, graphite
Discontinuous fibers: alumina, alumina-silica
Whiskers: silicon carbide
Particulates: carbon nano-tubes, silicon carbide, boron carbide, tungsten carbide.

The above listed fibres and particulates exhibit very high strength due to their crystalline structures, therefore by incorporating and orientating the fibres it gives the metal matrix body anisotropic properties. Thus a coupling can be made stronger and stiffer in the direction of the fibers than perpendicular to them. By appropriate selection of matrix materials, reinforcements, and layer orientations, it is possible to tailor the properties of a coupling to meet the needs of specific service requirements. For example, it is possible to specify strength and stiffness in one direction, coefficient of expansion and ductility in another, and so forth.

However of the available range of MMC's, carbon reinforced aluminium matrix are the cheapest and easiest to fabricate, therefore they are attractive to use for forming couplings between steel bodies. In embodiments, the method further provides means of coupling steel bodies with either aluminium or steel MMC body layers. Some anti corrosion precautions may be needed with aluminium although mild and alloy steel are close to aluminium on the galvanic table (−0.7 and −0.75 V) so galvanic corrosion is unlikely, but if it occurs the aluminium is sacrificed. In aircraft structures steel bolts are sometimes coated with an aluminium alloy, to provide an “aluminised” surface said to prevent galvanic corrosion. In embodiments an aluminised coating is applied to a steel first body layer to prevent galvanic corrosion when a aluminium MMC second body layer is pressed against it. Another precaution is to prevent water penetrating into trap space at the enhanced friction interface by using a hydrophobic non-conducting friction enhancement medium such as the preferred siloxane based compositions.

Further examples of composite materials suitable for the method range from carbon-carbon composites to glass or ceramic reinforced polymers. The carbon-carbon materials are extremely hard and very well suited to compressive loading. These materials are extremely expensive and mainly used for disc brakes and pads on aircraft or formula one or other high performance cars. The polymer matrix materials such as glass-reinforced epoxy are less strong but have the advantage of being insulators but are not compatible with the friction-enhancing materials used on most common metals. Suitable glass or ceramic reinforced composites employ a polymeric matrix such as epoxy, which are less strong than MMC materials and much cheaper. Materials employing a polymeric matrix, for example an epoxy, carrying insulating reinforcement fibres, for example glass fibre, have the advantage of being electrical insulators, into which electrical conductors can be introduced. This requires means of providing electrical connection across the pipe coupling between coupled together bodies made with electrically insulating materials. Thus either a bridging plug and socket arrangement must be provided or the conductors must be exposed at the tube end so that abutting or overlaying conductor pads can make reliable bridging contact. Such means of providing electrical contacts are known, and they impose stringent requirements upon alignment between the coupled tubes and provision must be made to positively locate in both the axial and radial planes within said coupling. In embodiments the layered coupling of the method provide means of forming improved electrical couplings within the overlaps within couplings made by the method, wherein the actual electrical contact surfaces are protected from contamination both from internal and external sources.

In embodiments, the materials of the bodies of the first, second and third body layers are electrical insulators suitable for carrying implanted electrical conductors therein and thereon to provide a multiplicity of electrical coupling paths through or across a coupling between bodies made by the method.

In embodiments, a suitable friction-enhancing fluid medium for use with epoxy matrix composites is a formulation carrying an epoxy solvent such as dimethylformamide.

In embodiments, any of either both of the first or second bodies are comprised of metal or one of said bodies is comprised of metal and the other comprised of a composite with a metal matrix. In embodiments, the metal friction-enhancing fluid medium is selected from the group consisting of CCU, a low molecular weight hydrocarbon or a siloxane, preferably hydrogendimethylsiloxane.

In embodiments, one of the first or second bodies is comprised of a metal or a metal matrix composite and the other is comprised of a plastic polymer or a fibre reinforced polymer matrix and the friction-enhancing fluid medium is a either a slurry capable of forming mechanical interlocks or an agent capable of temporarily softening said polymer matrix to facilitate slide resistant intimate contact therebetween. In embodiments, any of the first, second and third body layers has anisotropic structural properties, preferably wherein said anisotropic properties result from the presence of reinforcement fibres, reinforcement whiskers, single crystal whiskers or nano-particulates therein. In embodiments, wherein body layers with anisotropic properties are used, the second body layer is stronger in the direction of the coupling axis and the third body layer is radially stronger in the direction about the axis.

Metal matrix composite (reinforced) bodies with the desired anisotropic properties for use in the second layer are conveniently manufactured to near finished size by mixing appropriate powdered metal mixed with short lengths of suitable reinforcement fibre or on a microscopic scale suitable nano-particles then extruding prior to sintering, the extrusion process providing the desired orientation of the reinforcing elements to provide the desired anisotropic properties. Alternatively, for larger components reinforcement fibres may be layered in the desired direction with suitable metal powder prior to sintering.

A radially strengthened body suitable for use in the third layer is conveniently made by layering fibres by winding onto a suitably sized bar mandrel with powdered metal suitably integrated between windings prior to sintering to produced a near finished size metal matrix composite third body with the desired anisotropic properties.

In embodiments, the second body layer is releasable from frictional contact with the first body layer upon removal of third body layer to facilitate disassembly of the coupling. In embodiments, the second body layer is releasable upon sliding the third body off or out of the second body, depending upon the coupling configuration employed, thereby allowing the second body to separate from the first body. In embodiments, the second body layer is elastically deformabie such as to relax upon removal of third body layer.

In embodiments, to facilitate assembly and disassembly of subject couplings made by the method the radially deformabie second body layer is split along its axis to allow it to open and spring away from the first body layer as the third body is slid off. An optional compressible seal is provided along the split to prevent leakage along the split after assembly. Furthermore the split in the second layer bodies may take the form of machined slots again running in the general direction of the coupling axis (direction of sliding) and may be similar to those employed on machine tool collets, and these slots require sealing with compressible seals also when coupling flow bores. If the second body layer does not spring open sufficiently to clear any undercuts or surface roughness then the introduced slots may be further prized open by inserting a suitable tool.

In embodiments, the second body layer is divided into separate segments with compressible seals positioned between the segments and upon assembly of either a split second layer body, or a collet like body or a number of segments with seals may need to be preassembled and compressed with an appropriate tool, like tongs, to facilitate the engagement of the slideable third body.

In practice, the disassembly feature is most important in applications such as coupling and uncoupling lengths of tube or pipe for applications such as drill strings used for drilling bores either laterally or deep into geological strata. A suitable configuration for such applications is to arrange the coupling with abutting lengths of drill pipe forming the first body layer and the second radially deformable axially reinforced body layer positioned by sliding over the outside of the first layer straddling abutting ends of the drill pipes and finally the radially strengthened third layer is slid over the second layer to create a sealed high friction interlocking coupling. The third slideable layer needs to be secured by some means such as circlips, threaded nuts or radially positioned pins as illustrated later herein with reference to an example with diagrams, to prevent the third layer being inadvertently pushed off as it rubs against the drilled bore.

If the second layer (or segments thereof) are made of low modulus material such as soft aluminium or killed steel they will have relatively small elastic range and therefore are more readily plastically deformable. Equally if such materials are employed as a metal matrix with fibre reinforcement running in the direction of sliding the said metal matrix composite will be readily plastically deformable in the radial direction. In embodiments, the second body layer comprises a ductile metal that is plastically deformable such as to remain in high frictional contact with first body layer. In embodiments, this applies if the second layer is a split tube or is made with a number of segments. The resultant coupling is more difficult to disassemble if the second layer is not split and might be said to be permanent, although in practice it can be disassembled by cutting the second layer so as to introduce a split and prizing it off the first layer bodies.

In embodiments, the coupled body parts are tubular such as to form a sealed flow bore as used in pipe lines, drill strings, domestic or industrial plumbing for process plant or structural members.

In practice both permanent and undoable couplings made by the method can be designed to transmit rotary mechanical motion. In embodiments, the coupled body parts may be hollow or solid and cylindrical as used for torque transmission shafts, tie rods, power cables, wire ropes and drill strings.

It is frequently necessary to mechanically lock the slideable third layer body in position to prevent it being inadvertently slid off and prematurely releasing the coupling. In embodiments, there is additionally provided means of retaining the third body layer by means of a releasable retainer, wherein release of said retainer is used to facilitate disassembly of the coupling.

In embodiments, the method herein provides an improved method of making high grip couplings employing friction-enhancing means, especially for coupling relatively thin wall co-axially arranged metal bodies and minimise the risk of buckling and distortion due to very high sliding resistance experienced while press fitting in the presence of friction-enhancing fluid mediums.

In embodiments, the method further provides means of incorporating additional radially expandable interlocking features between the friction-enhanced interfaces, said features used to imbue the coupling with further useful features such as sealing, improved axial location, forming couplings between dissimilar materials etc.

The principle of forming mechanical interlocks between roughness to resist sliding is known. It is also known to create interlocks in the form of an accurately machined raised radial portion that locate in a matching accurately machined grove in a touching face. This provides what's known as a positive locating interlock. The method herein in embodiments, combines within a coupling locating interlocks with friction-enhanced overlaps wherein the locating interlocks provide additional axial strength and the friction-enhanced areas resist sliding under torsional loading. This arrangement is beneficial in reducing the actual overlap required in structural couplings because the potential sliding distance to catastrophic failure (disconnection) in the axial direction is a limiting design parameter, whereas if any rotary slippage occurs in structural couplings they distort rather than disconnected. For completeness similar positive location features may be incorporated to facilitate precise radial and axial alignment and both can have friction-enhanced areas interspersed between said location features.

In embodiments, there is provided means of axially locating bodies within a coupling made by the method herein which there is provided one or more positive interlocking features in either the axial or rotary axis or both.

In embodiments, the method provides a friction reduced sliding interface between the second and third body layers and a friction-enhanced non-sliding (load bearing) interface between the second and first body layers, said high friction load bearing interface is created by sliding the low friction interface only. Therefore in practice although the actual force required to slide the slideable third body into position may still be significant it is only applied between bodies in the second and third body layers and therefore does not affect thin walled coupled together bodies in the first layer. The sliding assembly force is applied between an end of the second body layer and its opposite distant end of the third body layer. Thus if the purpose of the coupling is to couple two thin wall bodies in the first layer, the coupling is assembled without applying any compressive force to the thin wall parts.

According to another aspect of the present invention there is provided a method of forming a coupling between a first body and a second body, the method comprising:

(i) positioning said first body and said second body such that a first surface with micro roughness of the first body is brought into near contacting relationship with a second surface with micro roughness of the second body, wherein space is defined between the micro roughness of the first and second surfaces;
(ii) introducing a friction-enhancing fluid medium to said space between said first and second body surfaces;
(iii) moving said first body towards said second body to thereby deform the micro roughness of the first surface and/or second surface, thereby reducing the space between the first and second body surfaces and consequently (a) expelling a first part of said friction-enhancing fluid medium and (b) defining trap space between the first and second body surfaces for trapping a second part of said friction-enhancing fluid medium; and
(iv) further moving said first body relative to said second body to thereby further deform the micro roughness of the first surface and/or second surface in the presence of said second part of the friction-enhancing fluid medium within said trap space, to thereby form the cold pressure welding contact.

According to another aspect of the present invention there is provided a method of forming a coupling between a first body and a second body, the method comprising:

(i) positioning the first body and the second body such that the first body layer surface is brought into near or light contacting relationship with the second body layer surface;
(ii) applying pressing force to press the second body layer against the first body layer to deform the micro roughness of the first body layer surface and/or second layer body surface and to thereby
(A) reduce the inter-micro roughness space between the micro roughness of the first body layer surface and/or second body layer surface and consequently to (a) expel a first part of said friction-enhancing fluid medium and (b) define trap space between the first and second body layer surfaces for trapping a second part of said friction-enhancing fluid medium; and
(B) form cold pressure welds at asperity contacts between the first body layer surface and second body layer surface in the presence of said second part of the friction-enhancing fluid medium within said trap space,
   such as to form said cold pressure welding contact, wherein the coupling between said first body layer and second body layer is maintained by said pressing force and upon removal of the pressing force, said cold pressure welding contact fractures to allow for release of the second coupling.

### DESCRIPTION OF THE DRAWINGS

Some practical embodiments and examples of the method are now described with reference to the following diagrams:

FIG. 1—A cross section schematic view of a tubular coupling with the second and third body layers on the outside of coupled together tubes in first tubular body layer.

FIG. 2—A cross section schematic view of a tubular coupling with the second and third body layers on the inside of coupled together tubes in first tubular body layer.

FIG. 3—A cross section schematic view of a tubular coupling in which the coupled together bodies form the deformable second body layer and, first layer on the outside.

FIG. 4—A cross section schematic view of a tubular coupling in which the coupled together bodies form the deformable second body layer and first layer on the inside.

FIG. 5—A cross section schematic view of a tubular coupling in which the coupled together bodies form the deformable second layer with first body layer in outer recess.

FIG. 6—A cross section schematic view of a tubular coupling in which the coupled together bodies form the deformable second layer with first body layer in inner recess

FIG. 7—An example of a practical embodiment of the method, showing the components of a coupling based on the configuration shown in FIG. 1.

FIG. 8—An example of a practical embodiment of the method showing the components of FIG. 7 assembled into a coupling.

FIG. 9—An example of a practical embodiment showing the coupling of FIG. 8 with s segmented second deformable layer and with introduced undercuts.

FIG. 10—An example of a practical embodiment based on the configuration shown in FIG. 3, in which a tapered threaded coupling is attached to a tubular body.

FIG. 11—An example of a practical embodiment based on the configuration shown in FIG. 4, in which a tapered threaded coupling, is attached to a tubular body.

FIG. 12—An example of a practical embodiment based on the configuration shown in FIG. 2 for retaining a tubular expandable dowel pin to couple non-tubular bodies.

FIG. 13—An example of a coupling based on FIG. 2 with a solid pin as body layer three that deforms body layer two (dowel) to couple non-tubular bodies in layer one.

FIG. 14—An example of a coupling based on FIG. 2 with two tubular bodies in layer three that deforms body layer two (dowel) to couple non-tubular bodies in layer one.

FIG. 15—An example of a coupling based on FIG. 2 with two solid bodies in layer three that deforms body layer two (dowel) to couple non-tubular bodies in layer one.

FIG. 16—A cross section view of prior art disclosed in U.S. Pat. No. 4,093,052 showing a fluid actuated coupling assembly otherwise described as a hydro-mechanical coupling.

FIG. 17—An example of the friction enhancing fluid applied to the shaft in FIG. 16 in which the expandable coupling corresponds to deformable layer two in the Method.

FIG. 18—An example of the friction enhancing fluid applied to the shaft and outer coupling face of FIG. 16 to form two friction enhanced interfaces by the Method.

FIG. 19—An example of a practical embodiment of the method, in which a hydro-mechanical coupling deforms to presses a coupling sleeve against two shaft ends in presence of friction-enhancing fluid medium

FIG. 20—An example of a practical embodiment of the method, in which two hydro-mechanical couplings deform independently to press the coupling sleeve against a single shaft end in presence of friction-enhancing fluid medium

FIG. 21—An example of an embodiment of the method, in which a fibre reinforced outer band surrounds a hydro-mechanical coupling that deforms and press a fibre reinforced coupling sleeve against two shaft ends in presence of friction-enhancer.

FIG. 22—An example in which an expandable hydro-mechanical coupling is used with the friction-enhancing fluid medium to couple bodies with aligned bores.

FIG. 23—An example in which an expandable hydro-mechanical coupling (body layer three) is used to expand a fibre reinforced coupling sleeve (body layer two) with the friction-enhancing fluid medium to couple the bored bodies (body layer one)

FIG. 24—An example in which two expandable hydro-mechanical couplings (body layer three) expand a half the fibre reinforced coupling sleeve (body layer two) treated with the friction-enhancing fluid to couple bored bodies (body layer one).

FIG. 25—An example in which an expandable tapered body (body layer three) is used to expand a fibre reinforced coupling sleeve (body layer two) to trap friction-enhancing fluid medium and frictionally couple the bored bodies of (body layer one).

FIG. 26—An example in which two expandable tapered bodies (body layer three) are used to expand a fibre reinforced coupling sleeve (body layer two) to trap friction-enhancing fluid medium and frictionally couple the bored bodies of (body layer one).

FIG. 27—An example in which two sliding tapered bodies (body layer 3) operate to press a reinforced deformable coupling sleeve against two shaft or tube ends (body layer one) to couple the ends. A fibre reinforced band around the outside of body layer three provides extra strength to the coupling.

FIG. 28—A schematic diagram showing a single point cutting tool creating a surface with micro-roughness suitable for use with the method.

FIG. 29—A schematic diagram illustrating two surfaces with similar micro roughness in near contacting relationship.

FIG. 30—A schematic diagram illustrating two surfaces with similar micro roughness in minimal asperity contacting relationship and maximum trap space.

FIG. 31—A schematic diagram illustrating two surfaces with similar micro roughness in maximum asperity contacting relationship and minimum trap space.

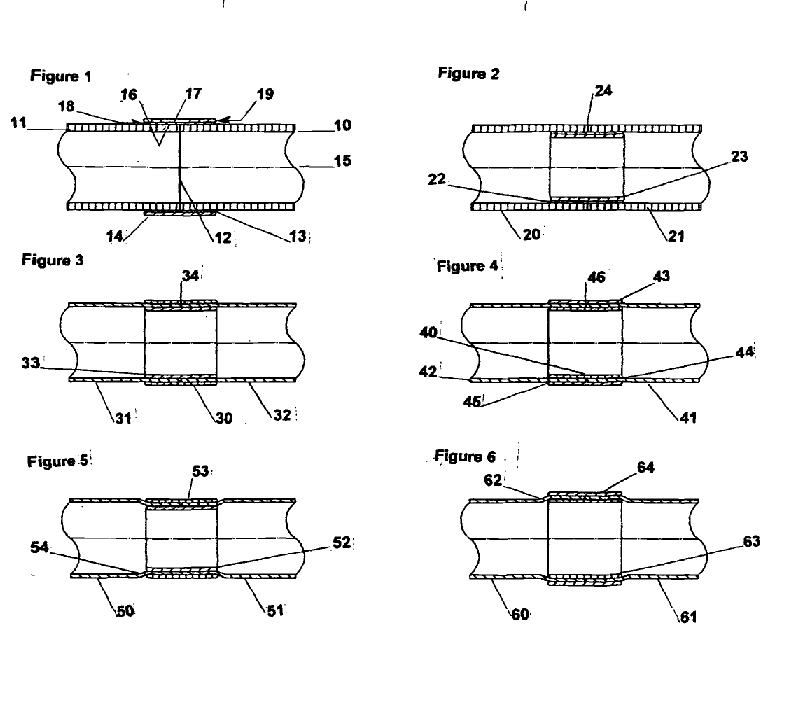

FIG. 1 shows a schematic cross section of an assembled example of the subject coupling configured for sealably coupling tubular bodies 10 and 11, in which coupling there are three body layers. The first non-deformable body layer containing two tubes 10 and 11 shown positioned in abutting sealable relationship at 12. The second and deformable body layer has a single overlapping body 13 sandwiched between the non-deformable outer third overlapping body layer 14. All the bodies contained in the body layers are aligned on a common axis 15 and are therefore said to be arranged in a co-axial relationship. The body of the second layer 13 with a first face in high friction contact with bodies 10 and 1 in first body layer and a second face shown in low friction contact with the body of the third body layer 14. There is introduced at interface 16 between the first body layer 10 and 11 and the second body layer 13 a friction-enhancing fluid medium. There is introduced at interface 17 between the third body layer 14 and the second body layer 13 a friction reducing agent.

Before assembly the outer surfaces of tubes to be coupled are cleaned in the area of the overlaps to leave them smooth and free of contaminates or corrosion. The body of the second body layer 13 is deformable and sized to initially be a close free sliding fit over the tubes 10 and 11. A friction-enhancing fluid medium rubbed on tubes 10, 11 with a suitable impregnated mildly abrasive pad, introduced between the tubes 10, 11 and 13 at 16, applied before positioning body 13, the second body layer over abutting bodies 10 and 11 so as to bridge abutting tube ends at 12. The bore of body 14 in the third body layer is sized smaller than the outside diameter of body 13 in the second body layer. A friction reducing agent (a lubricant) is applied to either outer face of the body 13 or the bore face of the body in the third body layer 14 and an external force is applied at 19 to body 14 reacting against 18 to force 14 over the deformable body 13 in the second body layer, compressing body 13 and forcing it into high friction contact at 16 against bodies 10 and 11 to secure the coupling. This coupling configuration provides an unimpeded smooth flow-bore.

FIG. 2 shows a schematic cross-section view of a second assembled example of the subject coupling configured with the layers reversed from FIG. 1, so the outside of the coupled tubes are flush. Again the coupling comprises three body layers, but access must be available to the inside to assemble the coupling. The first body layer has two bodies 20 and 21 abutting at 24 being coupled by under-lapping deformable body 22 of body layer two that is deformed by the third body layer body 23 as it is forced into body layer 22. Again a friction-enhancing fluid medium is introduced at the interfaces between bodies 20 and 21 in the first body layer and body 22 in the second body layer, these bodies initially being a free sliding fit. A lubricant is introduced at the interface of the interfering fitting body 23 in the third layer and 22 in the second body layer to minimise the force required to radially deform (expand) the second body 22 as 23 is forced inside 22 forcing 22 into high friction contact with bodies 20 and 21 in the first body layer to create a high friction load bearing interface. The assembly steps employed herein being substantially as described by reference to FIG. 1 hereinbefore.

FIG. 3 is a schematic cross-section view of a third assembled example of the subject coupling that is configured differently to the previous two examples, but still employs three co-axially arranged body layers. The first non-deformable body layer in this example has only one body 30 and this outer sleeve is sized to be a free fit initially over the deformable tubes being joined 31 and 32 that constitute the second body layer. The tubes sealably abut at 34. The third body layer has a non-deformable single body 33 that is an interfering fit with and expands bodies 31 and 32 as it is forced into the position shown. Again a friction-enhancing fluid medium is introduced between bodies in the first and second body layers 31, 32 and 30 and a lubricant is introduced between bodies in the second 31, 32 and third body layer 33 to facilitate assembly. Body 30 is forced into the bore to expand bodies 31 and 32 into frictional coupling with body 30. The assembly steps employed herein being substantially as described by reference to FIG. 1 hereinbefore.

FIG. 4 is a schematic view of a cross-section of a fourth assembled example of the subject coupling configured differently again to the previous three examples wherein the first non-deformable body layer 40 is positioned inside the deformable second body layer shown containing two bodies 41 and 42 abutting at 46 and the third body layer contains a single non-deforming tube 43 positioned on the outside. The interface 44 between first layer body 40 and second layer bodies 41 and 42 has a friction-enhancing fluid medium introduced therein. The interface 45 between second body layers 41 and 42 has a friction reducing agent introduced therein. The coupling is assembled by first positioning the body in the first body layer 40, which is initially sized to be a close slideable clearance fit inside the bodies 40 and 41, the bodies of the second body layer. The body 43 of the third body layer, which is an interfering fit over bodies 41 and 42, is lubricated and slid into the position shown to compress and deform the bodies 41 and 42 to force them into high friction contact with the body 40 of the first body layer. The assembly steps employed herein being substantially as described by reference to FIG. 1 hereinbefore.

FIG. 5 is a schematic view of a cross-section of a fifth assembled example of subject coupling arranged in the same configuration as FIG. 3 but differs in that sections of the bodies of the second layer 50 and 51 are pre-formed at 54 to reduce their diameter. The purpose of reducing this diameter is firstly to simplify assembly because the interfering body 52 can be passed freely through tubes 50 and 51 prior to and during assembly. The second purpose is to provide a coupling in which the body of the first layer 53 is left flush with the coupled together tubes 50 and 5. Otherwise the join shown herein is identical to that shown and described more fully with reference to FIG. 3 hereinbefore. The assembly steps employed herein being substantially as described by reference to FIG. 1 hereinbefore.

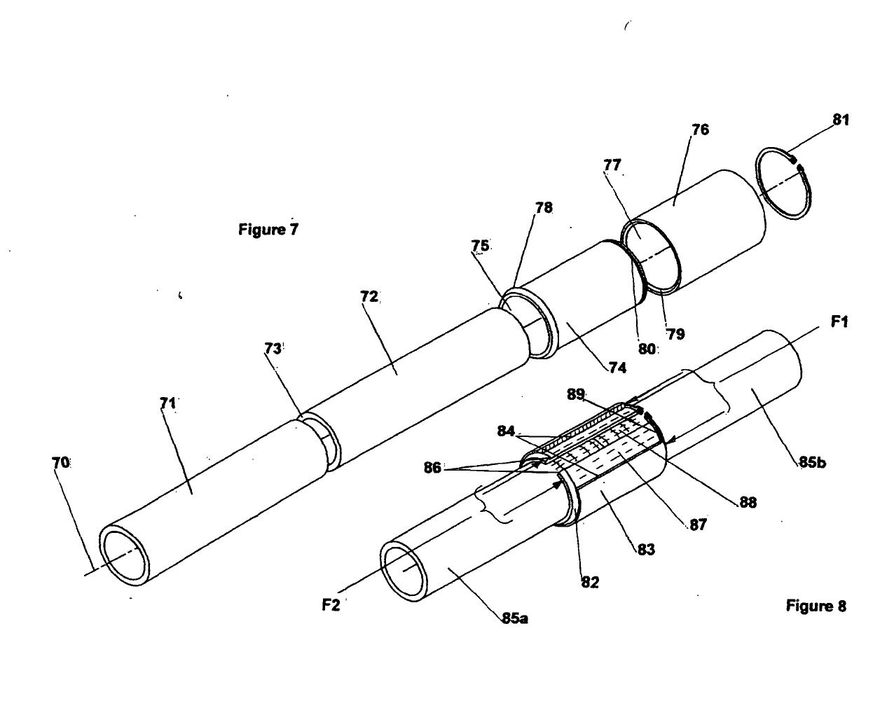

FIG. 6 is a schematic cross-section view of a sixth assembled example of subject coupling arranged in the same configuration as FIG. 4 but differs in that sections of the bodies of the second layer 60 and 61 are formed at 62 to increase their diameter. The purpose of increasing this diameter is firstly to simplify assembly because the interfering body 64 in the third body layer can be passed freely over tubes 60 and 61 prior to and during assembly. The second purpose is to provide a coupling in which the body of the first layer 63 is left flush on the inside with the coupled together tubes 60 and 61. Otherwise the join shown herein is identical to that shown and described more fully with reference to FIG. 4 hereinbefore. The assembly steps employed herein being substantially as described by reference to FIG. 1 hereinbefore. By way of an example FIGS. 7 and 8 illustrate a practical coupling based on the configuration shown in FIG. 1. In FIG. 7 the individual components of the coupling are shown strung along an extended common axis 70. The first body layer comprises the two tubular bodies 71 and 72. These bodies should be cleaned at this stage before assembly to ensure all contamination and corrosion is removed; if the bodies are metallic their mating surfaces should be bright clean metal. The end faces 73 are prepared to precisely abut and thereby form a seal when pressed and held together. Although not shown in this example a compressible seal may additionally be trapped between these abutting ends 73 in which case the ends may be suitably shaped to receive and retain said seals. The second body layer is provided by body 74, this is a deformable sleeve whose bore 75 is sized to slide freely over tubes 71 and 72. The surface of bore 75 should again be clean, smooth and parallel. The third body layer is provided by a further sleeve 76 whose bore 77 is sized slightly smaller than the outside diameter of sleeve 74. Sleeve 76 is essentially non-deformable, being stiff enough to deform deformable body 74 as it is forced into an overlapping relationship therewith. An entry taper 79 is provided to bore 77 to assist in sliding sleeve 76 over sleeve 74. Sleeve 74 also has a raised edge 78 provided to retain sleeve 76 and a grove 80 is provided to accommodate a circlip 81 to retain sleeve 76 in place after assembly.

FIG. 8 shows a cut away view the parts of FIG. 7 assembled into a coupling according to the method made between tubular bodies 85a and 85b and these tubular bodies comprise the first body layer. Sections of overlapping body layer two 82 is shown cut away at 86 and body layer three 83 is cutaway at 84 to reveal the friction reduced interface 87 indicated by minus signs and the friction-enhanced interface 88 indicated by plus signs.

The coupling is assembled by first abutting the ends of tubular bodies 85a and 85b. Then selecting and applying a suitable friction-enhancing fluid medium to the surface 88 (the friction enhanced area marked with ‘+’ signs). The friction enhanced area is overlapped by deformable body 87, whose outer surface is shown covered in ‘−’ (minus signs) to indicate that a friction reducing agent has been applied to 87. Sliding sleeve 83 is slid into the position shown by applying force F1 in the direction of the arrows applied to the end face of 83 to force body 83 over body 82 as it is supported at its end face by reaction force F2. The sliding force is minimised by the introduction of the friction reducing agent at 87. The sliding body of the third body layer 83 compresses and deforms the body of the second body layer 82 into contact with the bodies of the first body layer 85a and 85b, thereby forming a high friction load bearing interface at 88. The final stage of assembly is to engage the circlips 81 into slot 89 to secure the slideable outer body 83 to prevent inadvertent displacement.

By way of guidance for couplings made with steel components, typically the coefficient of friction of the sliding interface 87 is typically less than 0.2, whereas the coefficient of friction on the opposing side of body layer two is greater than 0.8 and in may be as high as 4.

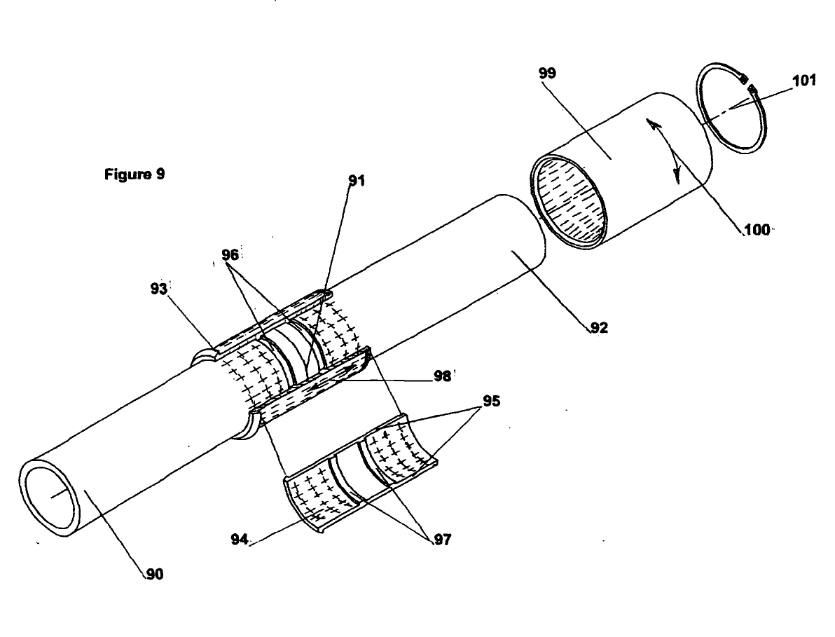

FIG. 9 shows a similar configuration of coupling to those of FIGS. 7 and 8 with additional embodiments, the following text should therefore be read as an extension of the previous coupling descriptions.

The coupling illustrated in FIG. 9 shows refinements over that shown in FIG. 8, in which a first tubular body 90 abuts at 91 against a second tubular body 92 both bodies in the first body layer according to the method. In a refinement, the second body layer comprises a segmented sleeve; the removed segment 94 illustrates the arrangement. In embodiments, the edges 95 of the segments are coated with thin deformable seals so that when the segments are pressed together they form a sealed cylinder.

In a further embodiment there are provided interlock-able grooves 96 in the face of tubular bodies 90 and 92 in which the radial raised portions 97 of the second body layer segments engage, thereby providing positive axial location. It will be appreciated that there can be more interlocking rings than shown, even to the extent that they occupy the entire overlap region between body layers one and two. Equally in cases where chemical means are unavailable for enhancing friction, perhaps because of material incompatibility, then the mechanical interlocks may be relied upon as the means of providing most of the axial coupling strength in a three body layer coupling as defined by the method herein.

Friction enhanced surfaces are indicated by array of plus signs and friction reduced surfaces are indicated by minus signs.

In a further embodiment the bodies of the second body layer and/or the third body layer have anisotropic properties such as may result by virtue of introduced reinforcement fibres. In the second body layer 93 the introduced fibres or particles are orientated in the direction indicated by arrow 98 which provides maximum strength and stiffness in the direction of the common axis 101 (sliding direction) to maximise the coupling strength between bodies 90 and 92 in the first body layer, thereby minimising the thickness required for the second body layer 93, while leaving these bodies 93 and 94 in second body layer deformable in the radial direction to facilitate maximum asperity contact welding and/or roughness interlocking at the interface between body layers one and two. In the body of the third body 99 bodies are provided with fibre reinforcement in the direction of arrow 100, which is normal to the axis 101, thereby maximising the hoop strength of body 99. As a result of said radial reinforcement the thickness of body 99 can be minimised. In a further embodiment, the selective introduction of reinforcement within overlapping body layers provides a stronger coupling assembly with minimual thickness and weight.

It will be appreciated that when body 99 is reinforced in the direction indicated 100 it becomes impractical to further radially expand a coupling assembled by the method. However if body 99 is made with a suitably ductile material, but stronger than the deformable bodies of the second body layer, then in principle, providing the other materials within the coupling are selected to be suitably ductile, the entire coupling may be expanded after assembly, even when the second body layer bodies 93 are reinforced in the axial direction 98, however provision must be made for relevant seals 95 to remain effective during and after expansion.

The above examples of FIGS. 7, 8 and 9 employ the configuration between three body layers as earlier described by reference to FIG. 1. It will be appreciated that by reversing the order of the layers similar joins can in principle be made using the configuration order illustrated in FIG. 2.

The configuration of FIG. 1 when employed in an exemplary coupling as illustrated in FIGS. 7, 8 and 9 provides a convenient coupling for use in thread-less drill pipes with the convenience of assembling and disassembling light weight drill strings. On the other hand the coupling configuration shown in FIG. 2 finds practical application in making more permanent structures where it is important to have strong flush joins made without applying external heat and where access to the bore interior is practical The couplings configured as in FIGS. 1 and 2 are suitable for coupling heavy duty tubular bodies that are themselves difficult or impractical to deform, and are principally made with metals, most commonly steel. In contrast the couplings illustrated in FIGS. 3 to 6 employ configurations more suitable for very thin wall metal tubular bodies or tubular bodies made with non-metals, such as glass fibre (glass reinforce epoxy resin matrix) that are sufficiently deformable.

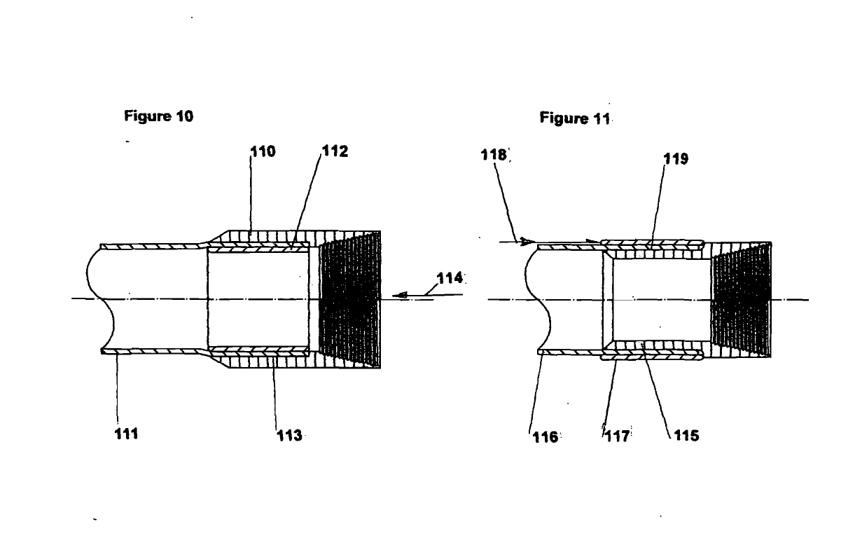

FIGS. 10 and 11 illustrate examples of couplings suitable for coupling either thin wall deformable metal or non-metal tubular bodies to terminals. In the example shown in FIG. 10 shows how a typical threaded terminal 110 is attached to a tubular body 111. The coupling of FIG. 10 is configured as previously described with reference to schematic FIGS. 3 and 5, in which the first body layer is the non-deformable outer first body layer 110 and is positioned on the outside of the deformable second body layer 111, the tubular body, which is deformable and the third body layer 112 is a slideable stiff sleeve that when slid into the position shown in the illustration deforms the second layer 111 against the first layer 110 to frictionally secure it. It will be appreciated that although not shown clearly because of the difficulty of scaling the interface 113 of the terminal body, that is the first body layer may have appropriate roughness when used to grip non-metals, but may be smooth when used to grip suitable metals if an appropriate siloxane based friction-enhancer is applied. The interface between the second body layer 111 and third body layer 112 is smooth and lubricated so that although sleeve 112 is larger than the initial inside diameter of tubular body 111, the later is readily deformed upon sliding the sleeve 112 into the position shown. The sleeve 112 is inserted in the direction of arrow 114.

The coupling of FIG. 1 is configured as described with reference to schematic FIGS. 4 and 6, in which the first body layer is the non-sliding stiff layer 115 and is positioned on the inside of the deformable second body layer 116, which is a deformable tubular body and the third body layer is a slideable stiff sleeve 117 that when slid in the direction of arrow 118 into the position shown in the illustration and deforms the second layer 116 against the first layer 15 to frictionally secure it along interface 119. The assembly is performed as described in relation to FIG. 10.

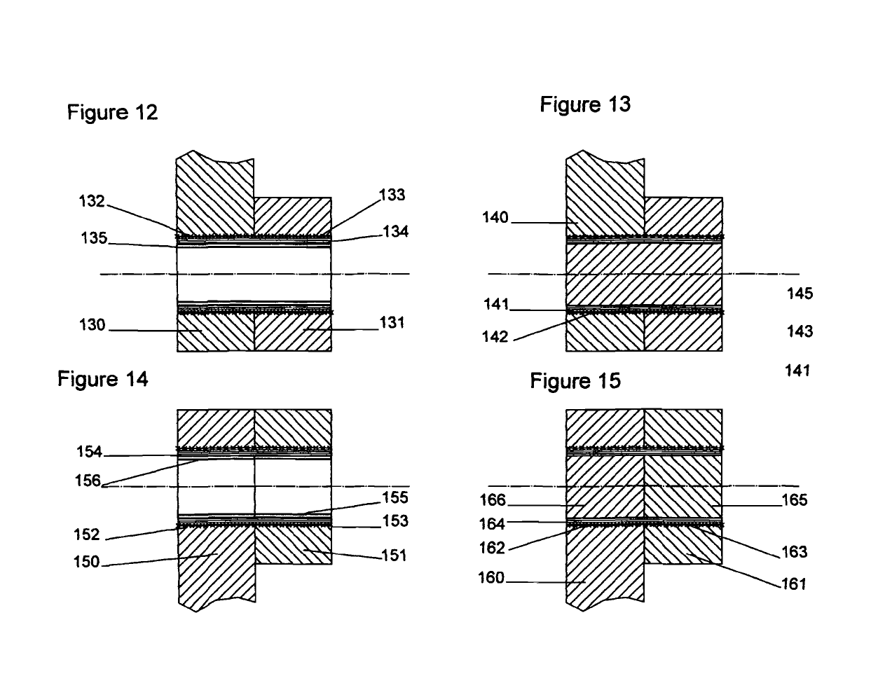

FIGS. 12 to 15 illustrate examples of how couplings employing the principles described hereinbefore are practically useful for locating (accurately positioning one with respect to another) then securing relatively large non-cylindrical bodies one against another, which process is highly beneficial in assembling machinery, especially in applications such as heavy duty structures where precise alignment is critical and must remain unaffected by vibration, applied loads and temperature variation, examples of such stringent requirements are typically found in large machine tool frames, construction and transportation equipment, oil filed extraction equipment, mining or ship building, wind turbines, tidal turbines and wave powered generators.

FIG. 12 is a cross section schematic view of a first body 130 and a second body 131, and these according to the method constitute the first body layer of a coupling, in which bodies there is provided precision bores 132 and 133 that are approximately aligned by inserting a loose fitting expandable straddling sleeve 134. Sleeve 34 is shown with horizontal shading to indicate the direction of optional mono fibre reinforcement allowing it to remain deformable at least in the radial axis and constitutes the second body layer according to the method. There is applied a friction-enhancing fluid medium between the bores 132 and 33 and sleeve 134. There is further provided a third stiff non-deformable sleeve 135 which is shown shaded with dots indicating optional mono reinforcement fibres wound radially to stiffen the sleeve, said sleeve has a lubricated interfering fit with 134. Upon forcing 135 into 134 the later expands to form a secure high friction contact with bodies 130 and 131. The practical benefit of the method in this application is that these dowels provide exceptionally high friction retention and stiffness but are assembled by applying relatively low and much more manageable forces due to the sliding interface between second and third body layers being lubricated.

High strength structures that might employ these couplings are invariably made of metal such as spheroidal iron or alloyed steel. The deformable sleeve 134 is beneficially reinforced to withstand high shear and tensile loads and may typically be a metal matrix composite with steel or aluminium matrix. The reinforcement selected to provide suitable anisotropic behaviour allowing it to spread radially while providing exceptional strength in tension and shear.

FIG. 13 is a cross section schematic view of a similar construction to that shown in FIG. 12 but differs by having a solid body as the third body layer. There is provided a first body 140 and a second body 141, and these according to the method constitute the first body layer, in which bodies there is provided precision bores 142 and 143 that are approximately aligned by inserting a straddling loose sleeve 144, which is deformable at least in the radial axis. Said straddling sleeve constitutes the second body layer according to the method and there is applied a friction-enhancing fluid medium between the loose fitting first and second body layers 140 and 141. There is further provided a third stiff sleeve 145 that provides a lubricated interfering fit with 144 and deforms 144 upon inserting to expand 144 into secure high friction contact with bodies 140 and 141. The practical benefit of the method in this application is that these dowels behave as solids and provide improved damping and greater stiffness than in the previous example of FIG. 12.

FIG. 14 is a cross section schematic view of a similar construction to that shown in FIGS. 12 but differs by having two bodies 155 and 156 in the third body layer which facilitates independent insertion and securing of the loose coupling sleeve 154 in either body 150 or 151. In summary, there is provided a first body 150 and a second body 151, and these according to the method constitute the first body layer, in which bodies there is provided precision bores 152 and 153. Before bringing the bodies 150 and 151 together and aligning the bores, sleeve 154 may be first inserted and secured with a friction-enhancer in either bore 152 or 153 as a first step by inserting as appropriate only one of the two bodies of body layer three (either 155 or 156). Then as a second step the second body can be located over the projecting 154 straddling sleeve and separately secured at a later stage or at a different location. Sleeve 154 constitutes the second body layer according to the method and there is applied a friction-enhancing fluid medium between the loose fitting first and second body layers as in the preceding examples. There are further provided two stiff bodies 155 and 156 that constitute the bodies of the third body layer, each with a lubricated interfering fit with 154 and each deforms only the part of 154, that part being where 154 overlaps, either 150 or 151, whichever applies. Again the practical benefit of the method in this application is that these dowels provide exceptionally high friction retention and stiffness but are assembled by applying relatively low and much more manageable forces due to the sliding interface between second and third body layers being lubricated. This example has the additional advantage of being a two part assembly, the two parts being implemented independently and if needed at different times and at different places.

FIG. 15 is a cross section schematic view of a similar construction to that shown in FIGS. 14 but differs by having two solid bodies 165 and 166 in place of the hollow sleeves 155 and 156 in FIG. 14 in the third body layer. This facilitates the independent insertion and securing of the coupling sleeve 164 in either body 160 or 161 thereby providing greater flexibility in the assembly of said couplings. In summary, there is provided a first body 160 and a second body 161, and these according to the method constitute the first body layer, in which bodies there is provided precision bores 162 and 163. Before bringing the bodies 160 and 161 together and aligning the bores, sleeve 164 may be first inserted and secured with a friction-enhancer in either bore 162 or 163 as a first step, then as a second step the second body can be located over the projecting 164 straddling sleeve and separately secured at a later stage. Sleeve 164 constitutes the second body layer according to the method and there is applied a friction-enhancing fluid medium between the loose fitting first and second body layers. There are further provided two stiff bodies 165 and 166 that constitute the bodies of the third body layer, each with a lubricated interfering fit with 164 and each deforms only the part of 164, that part being where 164 overlaps either 160 or 161, whichever applies. Again the practical benefit of the method in this application is that these dowels provide exceptionally high friction retention and stiffness but are assembled by applying relatively low and much more manageable forces due to the sliding interface between second and third body layers being lubricated. This example has the additional advantage of being a two stage assembly, the two stages being implemented independently and if needed at different times and at different places. It will be appreciated that any of the afore mentioned bodies or component parts that comprise a coupling made by the method may be made independently at separate locations and any friction reducing or friction-enhancing treatments applied may be applied independently at further locations then transported to the assembly site.

It will be further appreciated that coupling parts for implementing the method need to be kept free of corrosion before assembly. This is eased by making the bodies of stainless steel, which eliminates rust, however care is needed to select materials that are not at risk of stress corrosion cracking, a risk with some materials in the presence of brine (NaCl), however since the coupling is left in compression the risk of sudden failure due to stress corrosion is likely to be minimal. The internal surface of the body where the second body layer is to be located at is cleaned and treated with a protective layer of water repellent silicone grease. Furthermore, a layer of suitable adhering grease carrying friction-enhancing additives can be selected to protect surfaces before during and after immersion in water, the grease being displaced as the couplings are assembled, leaving the surfaces coated with desired friction-enhancing layer. Likewise a second type of grease that reduces rubbing friction can be applied to the low friction sliding faces to protect them from corrosion. By employing these means couplings treated with appropriate protective greases can be used to assemble couplings according to the method underwater. It is usual that the remotely treated surfaces are protected with appropriately strong mechanical packaging for transportation to the assembly site.

It will be further appreciated that the method described and illustrated by reference to FIGS. 14 and 15 in which two bodies are shown in the third body layer can be varied by use of only one expanding body. In FIG. 14 this means that either 155 or 156 may be omitted. If 155 is omitted the deformable body 154 is not expanded to fit in 51 and 151 remains a loose fit over 153, so 153 can pivot or rotate. Like wise if 156 is omitted then body 150 remains a loose fit on projecting pin 154. In FIG. 15 either body 165 or 166 may be omitted, if 166 is omitted body 160 remains loose and if 165 is omitted body 161 remains loose and either can rotate on projecting pin 164. Thus in both figures the un-deformed length of 154 and 64 constitutes a shaft on which another body can rotate. If the bodies 154 and 164 are part of shaft with a suitable hollow section that can be deformed then the method can also be used to couple a wheel of lever to the shaft or to build rotating structures such as crankshafts. In a further embodiment of the method a body of the second body layer takes the form of a shaft with a hollow section that is deformable to facilitate coupling of bodies to the shaft by the method.

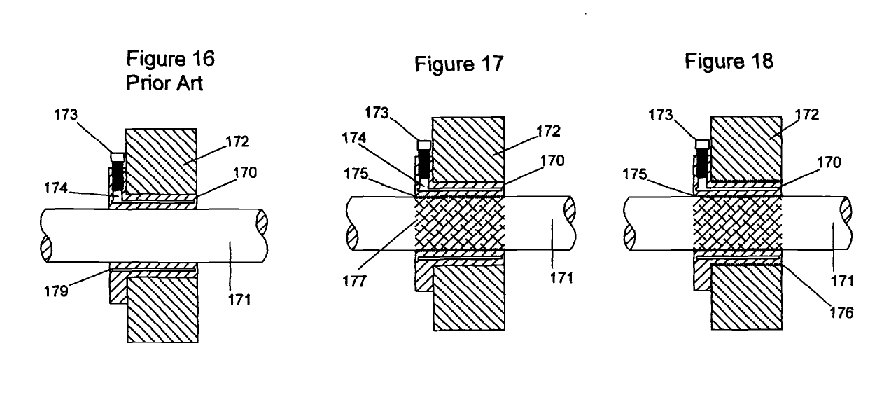

FIG. 16 shows prior art based on teachings of U.S. Pat. No. 4,093,052 disclosing a fluid actuated (expandable) coupling sleeve 170 inserted (sandwiched) between an inner shaft 171 and an outer body 172. Within the coupling sleeve 170 is an annular cavity coupled to chamber 174 with sealed compressor screw device. Said cavity and chamber are filled with a compressive hydraulic medium. The coupling sleeve 170 is a sliding fit on the shaft 171 and a sliding fit into the outer body 172. After assembling by sliding the sleeve and body into the relation ship shown in FIG. 16, the screw 173 is screwed inwards to pressurise the hydraulic medium to cause the annular chamber to expand, thereby expanding the sleeve 170 and pressing the sleeve 170 against the shaft 171 and outer body 172 and form a coupling. This method is suitable for coupling objects such as bushes and pinions to shafts but is limited both in the amount of coupling it provides and in its ability to withstand side thrust loads because the weak section 179 bounding the expanding cavity reduces the couplings ability to withstand shear forces acting in the direction of the shaft/coupling axis.

FIG. 17 shows by way of an example an improvement over FIG. 16 wherein the shaft 171 is prepared by lightly abrading with a fine abrasive pad to clean and refine the micro-roughness of the shaft surface in the region where the sleeve will be positioned 177. During or after abrading a thin film of friction enhancing fluid medium is also introduced to the surface and further rubbed on with the abrasive. After rubbing any resultant black oxide or other debris is gently wiped off leaving the surface with bright (reflective) clean appearance and still covered with a thin film of said introduced friction enhancing fluid medium, the thickness of the fluid layer being typically that of a human hair—about 20 micron. The surface of the inner bore 176 within the sleeve should be equally prepared clean and shinny and may optimally be similarly treated with the friction enhancing fluid.

The slidably fitting hydro-mechanical expandable sleeve 170, is then slid into position over the treated area 177 on the shaft 171 and the outer body 172 is positioned in their final lateral relationship prior to operating the screw 173 to expand sleeve 170 and secure the assembly. The introduced fluid results in an enhanced cold pressure weld developing at 175 the interface between the sleeve body 170 and shaft 171 at the treated interface 177.

FIG. 18 again shows by way of an example a similar construction as in FIG. 16 and differs over FIG. 17 in having the friction-enhancing fluid medium additionally applied to the outer coupling sleeve surfaces 176 prior to following the assembly procedure as described for FIG. 17 above.

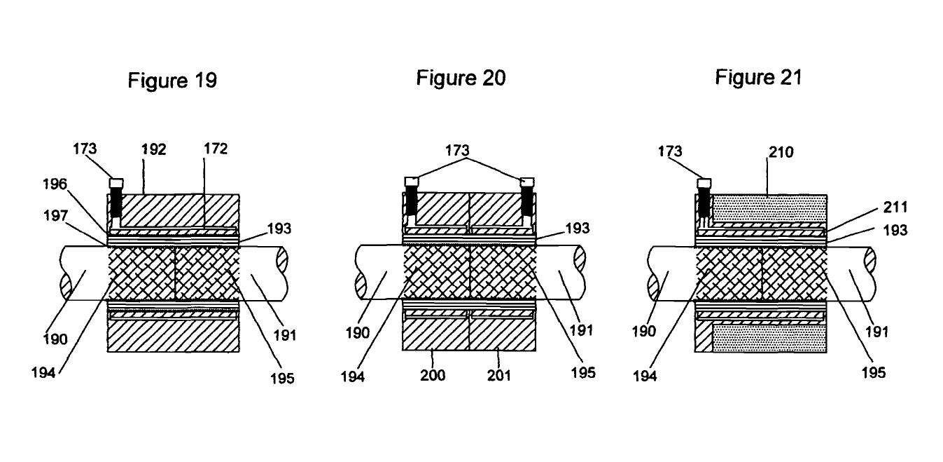

FIG. 19 shows by way of a further example a variation of the hydro-mechanical coupling method of FIGS. 16 to 18, in this case adapted for coupling together two abutting shaft ends 190, 191. It will be appreciated that said shafts might alternatively be tubular (hollow) in which case the coupling also provides a sealable union. Also there is introduced a coupling sleeve 193 made with a material selected to provide superior coupling strength. For example the horizontal shading shown on sleeve 193 symbolically represents the direction of optional fibre reinforcement that will maximise the axial and shear coupling strength. Preferably such fibre reinforcement will consist of mono fibres within a metal matrix composite (MC) structure, the metal selected to be compatible with the metals of the shaft and hydro-mechanical expansion sleeve and the friction-enhancing fluid medium. The metal of the matrix needs to be elastically deformable in the radial plane to facilitate it being pressed against the shafts 190, 191 as the compression screw 173 is screwed inwards to pressurise the expansion chamber 172 within the hydro-mechanically deformable body 192. The most common metals being used as a matrix medium being aluminium or alloys thereof of steel or alloys thereof.

The outer region of the hydro-mechanical coupling body 192 beyond the annular hydraulic expansion chamber 172 is made stronger than the inner region so that upon operating the screw 173 the hydro-mechanical chamber 172 expands inwards and presses the sleeve against the previously prepared shaft end surfaces 194, 195. Said surfaces 194, 195 and the inner contacting surface 196 of the coupling sleeve 193 prepared as described hitherto in relation to FIG. 17, the surfaces having been prepared clean with a mildly abrasive pad that also applies a thin film of friction-enhancing fluid medium.

The interface 197 between the coupling sleeve 193 and hydo-mechanically expandable sleeve 192 may optionally have a friction-enhancing fluid medium applied therebetween as shown, depending upon the desired coupling characteristics. A benefit of applying friction-enhancing fluid medium to interface 197 is that the body 192 can then withstand higher side forces that otherwise might displace 192 along the axis of the shafts possibly reducing the grip of the coupling sleeve 193 against a shaft end, either 190 or 191. Alternatively it may be beneficial in some applications where there are only low shear loadings on 192 to lubricate this interface on large couplings to assist in assembly and disassembly.

The coupling as depicted in FIG. 19 is assembled after cleaning and treating the appropriate surfaces 194, 195, and the outer coupling sleeve 197 by first arranging the abutting shaft ends 190, 191 within the coupling sleeve 193, then positioning the hydro-mechanical coupling body 192 over the coupling sleeve 193 then operating compressor screw 173 to elastically deform 192 into 193 and press 193 against shafts 190 and 191 interfaces, thereby to secure the coupling. The coupling is released by unscrewing the compressor screw. FIG. 20 shows a coupling that is similar to that of FIG. 19 except that it uses two hydro-mechanical expander sleeves 200 and 201, said sleeves aligned with respective shaft ends 190 and 191 to facilitate the securing and releasing either shaft from the coupling sleeve without affection the coupling to the other shaft. Otherwise the preparation and assembly of the coupling depicted in FIG. 20 is similar to those hitherto described in FIG. 19.

FIG. 21 again shows a coupling that is similar to that of FIG. 19 save for the use of a strengthened band 210 placed around a potentially thinned down hydro-mechanical expandable sleeve 211. The dot shading shown on 210 symbolically represent the ends of reinforcement mono fibres wound circumferentially around the expandable sleeve 211 to provides a stiff band that resists outward expansion as the hydro-mechanical sleeve 211 is pressurised to force coupling sleeve 193 against shafts 190 and 191 according to the method. It will be appreciated that in practice the thickness of the couplings sleeve 193 and outer reinforced band 210 will in practice be selected to provide the required strength, the actual thickness in practice therefore are likely to often be much thinner than shown symbolically herein.

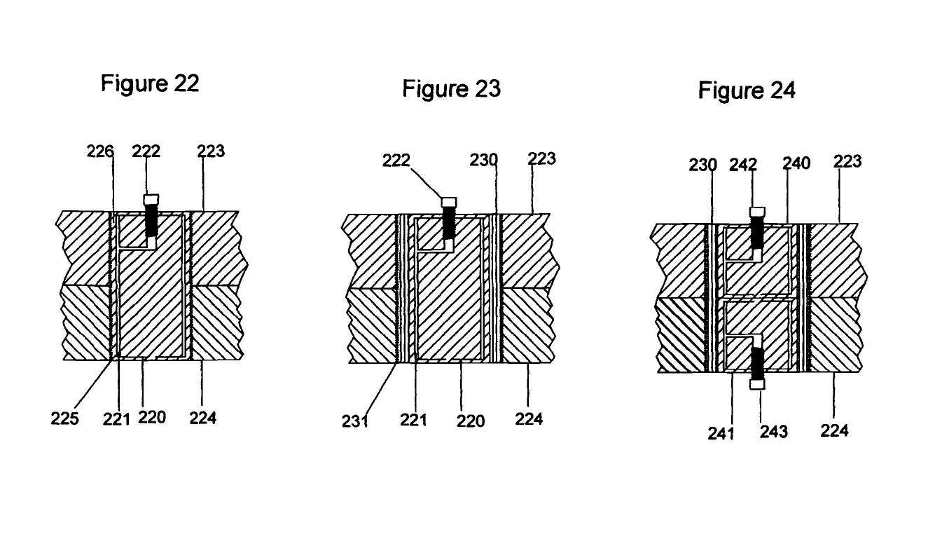

FIG. 22 shows an alternative configuration of a hydro-mechanical deformer based on the method shown in FIG. 16 but which expands only outwardly thereby making it suitable for insertion into and forming a coupling within a bore and very beneficially between bodies with aligned bores. In particular FIG. 22 is a schematic representation of a hydraulically expandable dowel pin 220 with an annular chamber 221 pressurised with hydraulic medium by the sealed compressor screw 222, the pin 220 insert inserted into aligned matching bores in bodies 223, 224. The inserted pin with a friction enhancing medium inserted between bodies 223, 224 and the pin 220 to form a friction enhanced interface 225 to improve coupling. The surfaces herein prepared clean and smooth by the method described in greater detail herein before. However any externally applied loads applied to this coupling pin 220 via the friction interface 225 are borne by the thin deformable section 226, which is undesirable.

FIG. 23 shows by way of a further example an improved coupling based on the from the coupling shown in FIG. 22 in which a strong deformable coupling pin is used to overcome the limitation identified with reference to the design shown in FIG. 22 above.

This coupling comprises a hydro-mechanical expandable inner pin 220 with an annular cavity 221 coupled to an operable sealed compression screw 222, said pin 220 initially sized to be close slideable fit into a coupling sleeve 230, which sleeve itself is sized as a close slideable fit into the aligned bores through bodies 223 and 224. Before assembling, the surface of the bores in bodies 223 and 224 are prepared clean by rubbing with a mildly abrasive pad optionally in the presence of the friction-enhancing fluid medium, then wiped to remove debris leaving a film covering the surface of approximately 20 to 40 microns thick. The outer surface of the coupling sleeve 230 is similarly prepared. The outer surface of the pin is cleaned and may be treated with either a lubricant to assist assembly or a friction-enhancing fluid medium to ensure retention of the pin over long period of alternating loads in service. The coupling is assembled by inserting the cleaned and treated coupling sleeve into the bores of bodies 223, 224, and then the expandable pin 220 is inserted into the coupling sleeve 230 and finally the compression screw 222 is screwed in to expand the pin 220, which deforms the coupling 230 into high friction grip with the coupled together bodies 223 and 224. The coupling sleeve can be beneficially made with MMC material, preferably selectively reinforced in the direction of its axis. FIG. 24 shows a similarly configured coupling to that of FIG. 23 but differs in the central expandable pin is divided in two 240,241, each half aligning with bodies 223, 224 respectively. The preparation of the surfaces is as previously described before assembly of the example of FIG. 23. The divided pin facilitates the insertion and securing a first end of the coupling sleeve in a first body (either 223 or 224) before aligning the second body with the first and the separately securing the second end of the coupling body into the second body. For convenience either body can be released independent of the other by unscrewing the appropriate compression screw either 242 or 243 and then reversing the procedure to reassemble.

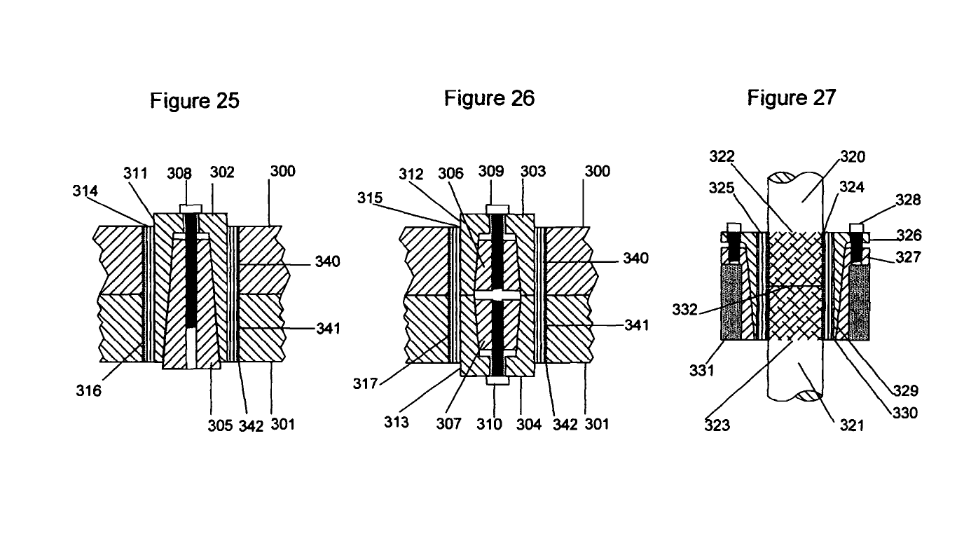

By way of the further examples illustrated in FIGS. 25 to 27 an alternative means of pressing the second body layer against the first body layer according to the method is provided, in which the third body layer is made expandable by sliding tapered bodies one against the other to deform the second body layer.

FIG. 25 illustrates an arrangement for securing a first body 300 of the first body layer with a first bore 340 aligned with a second bore 341 in second body 301 also of the first body layer. The bores 340 and 341 sized to be a close sliding fit with coupling sleeve 314 which is the deformable second body layer, shown 314 in the diagram with vertical shading lines to indicate this sleeve can be selectively reinforced with mono fibres in a metal matrix to maximise axial strength. The outer surface of the coupling sleeve being cleaned with a suitable mildly abrasive pad and coated with a film of friction enhancing fluid prior to being inserted into aligned bores 340 and 341 that are also cleaned before sleeve 314 is inserted.

The third body layer 302 is expandable by operating the screw 308 to draw a slidable lubricated tapered plug 305 up into the internally tapered body 302 thereby to expand 302 into contact with sleeve 314, thereby forming a first coupling between the third body layer 302 and the second body layer 314; and progressively forming a second coupling 316 between the first body layer 300 and 301 and the second body layer 314. As 305 is drawn further into third body layer 302 so it continues to elastically expand thereby pressing the surface of 314 hard against the bores 340 and 341 to create cold pressure welds therebetween at 316. The cold pressure welds are relaxed (fractured) by unscrewing 308 and sliding the internal body 305 outwards to allow 302 to elastically contract. To facilitate assembly the outer surfaces of the second body layer may be lubricated and the sliding tapered faces should be lubricated.

FIG. 26 illustrates an arrangement that functions in a similar way to the example shown in FIG. 25 except the expandable body is divided in two so that the coupling sleeve 315 can be secured into one or the other body either 303 or 304 first and then the second body of the first body layer can be aligned and slid over the projecting coupling sleeve 315 and secured. The bores 340 and 341 sized to be a close sliding fit with coupling sleeve 314 which is the deformable second body layer and shown 314 in the diagram with vertical shading lines to indicate this sleeve can be selectively reinforced with mono fibres in a metal matrix to maximise axial strength. The outer surface of the coupling sleeve being cleaned and coated with a film of friction enhancing fluid prior to being inserted into aligned bores 340 and 341 that are also cleaned before sleeve 314 is inserted as previously described for FIG. 25. To facilitate assembly the outer surfaces of the second body layer may be lubricated and the sliding tapered faces should be lubricated. As the third body layer 303, 304 expands, cold pressure asperity welds form at 342 to secure the coupling.

FIG. 27 illustrates a shaft coupling employing an alternative arrangement using sliding tapered expander to execute the method as follows: The first body layer comprises two shaft ends 320, 321 cleaned and treated with friction enhancing agent 322, 323 arranged in abutting relationship within the coupling sleeve 325, which constitutes the second deformable body layer according to the method and shown 315 in the diagram with vertical shading lines to indicate this sleeve can be selectively reinforced with mono fibres in a metal matrix to maximise axial strength. The third body layer according to the method is provided by an assembly comprising a first body 326 with a parallel bore sized to slidable fit over the coupling sleeve and a tapered outer body face 329 that slidably engages with a matching tapered inner body shape on body 327. Upon operating coupling screws 328 the body 327 presses against 326 to deform it inwards, causing 326 to come into pressing contact with deformable body 325 at 330. As screw 328 continues to be screwed in the second body layer is pressed against the first body layer to form a second coupling entrapping the friction enhancing agent and forming an array of cold pressure asperity welds between the second body layer and the first body layer according to the method. The third body layer also includes a strengthened section 331 shown with dotted shading to indicate optional strengthening with radially wound fibres in a metal matrix. Deformations in the second and third body layers are within the bodies elastic range, thus upon releasing (unscrewing 328) the pressure between body layers one and two falls and the cold pressure weld fracture to facilitate disassembly of the coupling. To facilitate assembly the outer surfaces of the second body layer may be lubricated and the sliding tapered faces should be lubricated, care must be taken to avoid friction-enhancing fluid medium reaching the tapered faces.

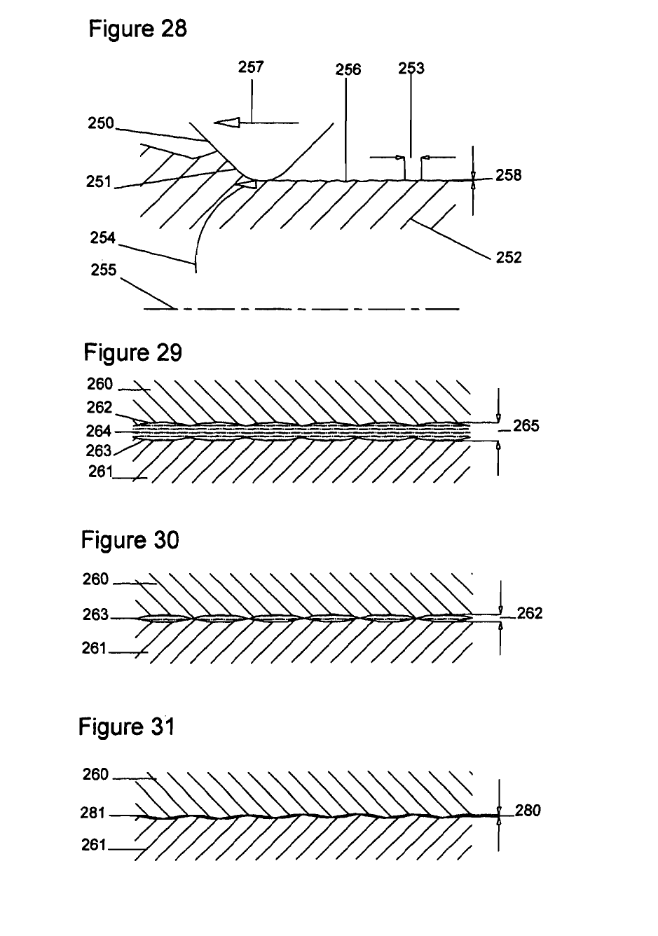

FIG. 28 illustrates a process for preparing a surface that appears smooth yet under a microscope it is seen to have roughness often described as micro-roughness, suitable for use with the method. FIG. 28 shows a body layer being shaped with a radiused single point cutting tool 250 placed in cutting contact at 251 with a body layer 252 being rotated in direction 254 against the cutting tip 251. The cutter is steadily moved (indexed) in direction 257 by the distance 253 for each revolution of the body 252. With optimum cutting parameters such a single point surface machining operation will provide a clean cut without tearing or galling, providing a repeating shallow scallop like texture 256 resembling a fine helix or screw thread that is open and easily cleaned of debris and cutting oil residues with a mildly abrasive pad such as a 3M's ScotchBrite colour code green or finer. The deviation 258 of the scallop like texture about a mean centreline is referred to as the centre line average, an ISO standard measurement designated as Ra measured on a profileometer. Ra is varied by adjusting the feed rate 253. Desirably in the method the Ra of the scallop textured surfaces shown should be less than 2.5 micron, preferably less than 0.8 micron. FIG. 29 shows a x3 magnification of two cross sections of identical body layers 260, 261 with surfaces 262, 263 respectively, prepared by the single point cutting process of FIG. 28. The surfaces 262, 263 are shown separated and supported apart by a film of friction enhancing fluid medium 264, typically applied by rubbing with the afore mentioned abrasive pad material. This diagram schematically corresponds to the spacing between the first and second body layer after preparing said surfaces according to the method after pre-positioning. This schematic diagram represents the near or light contacting relationship described hereinbefore. It will be appreciated that the surfaces shown here are idealised and not strictly to scale. In practice there will be random points of light contact across the gap at this stage of the method, however any such contact will be so light that it will not prevent sliding between body layers 260, 261 to pre-position them. Space 265 shown filled with friction enhancing fluid 264 is referred to hereinbefore as the inter-micro roughness space between the micro-roughness of the first body layer surface 262 and/or second body layer surface 263.

FIG. 30 shows the same bodies 260, 261 pressed into asperity welding contact at 263, thereby reducing the trap space within the combined micro roughness from 265 in FIGS. 29 to 262 to:

(A) reduce the inter-micro roughness space between the micro roughness of the first body layer surface and/or second body layer surface and consequently to (a) expel a first part of said friction-enhancing fluid medium and (b) define trap space between the first and second body layer surfaces for trapping a second part of said friction-enhancing fluid medium; and
(B) form cold pressure welds at asperity contacts between the first body layer surface and second body layer surface in the presence of said second part of the friction-enhancing fluid medium within said trap space.

FIG. 31 shows the same bodies 260, 261 pressed into asperity contact 281 and trapping less applied fluids in trap space 280 between welding asperities than shown at 262 in FIG. 30 because the opposing asperities contact the trough bottoms to double the contact count, although fewer welds are formed in FIG. 30 they are stronger than those of FIG. 31 because the point contact pressures are higher in FIG. 30 thus causing larger cold pressure welds to form. In the above examples, the friction-enhancing fluid medium may be any of those described hereinbefore as being suitable for use in the present method.

1. A method of forming a coupling between a first body and a third body, the method comprising:
I. selecting a first body having a first body layer and a third body having a third body layer;
II. sandwiching a deformable second body layer of a second body between said first body layer and said third body layer;
III. forming a first coupling between the third body layer and the second body layer; and
IV. forming a second coupling between the first body layer and the second body layer by providing a friction-enhancing fluid medium between the first body layer and the second body layer and, without introducing relative sliding there-between, pressing the second body layer against the first body layer such as to deform the second body layer into cold pressure welding contact with the first body layer.

2. A method according to claim 1, wherein said step of pressing the second body layer against the first body layer involves forcibly sliding the third body layer against the second body layer.

3. A method according to claim 1, wherein said step of pressing the second body layer against the first body layer involves expanding the second body layer or expanding the third body layer against the second body layer.

4-16. (canceled)

17. A method according to claim 1, wherein said first coupling between the third body layer and the second body layer is a low friction coupling.

18. A method according to claim 1, wherein on pressing the second body layer against the first body layer neither body layer is subject to bulk plastic deformation thereof.

19. A method according to claim 1, wherein the first body layer has a first smooth surface with micro roughness and said second body layer has a second smooth surface with micro roughness, wherein inter-micro roughness space is defined by the micro roughness of said first body layer surface and that of said second body layer surface, and wherein said friction-enhancing fluid medium is provided to said inter-micro roughness space of at least one of the first and second body layer surfaces.

20. A method according to claim 19, wherein said second coupling between the first body layer and the second body layer is a releasable coupling and wherein said forming step IV involves:
(i) positioning the first body layer and the second body layer such that the first body layer surface is brought into near or light contacting relationship with the second body layer surface;
(ii) applying pressing force to press the second body layer against the first body layer to deform the micro roughness of the first body layer surface and/or second layer body surface and to thereby
(A) reduce the inter-micro roughness space between the micro roughness of the first body layer surface and/or body layer surface and consequently to (a) expel a first part of said friction-enhancing medium and (b) define trap space between the first and second body layer surfaces for trapping a second part of said friction-enhancing fluid medium; and
(B) form cold pressure welds at asperity contacts between the first body layer surface and second body layer surface in the presence of said second part of the friction-enhancing fluid medium within said trap space,
such as to form said cold pressure welding contact, wherein the coupling between said first body layer and second body layer is maintained by said pressing force and upon removal of the pressing force, said cold pressure welding contact fractures to allow for release of the second coupling.

21. A method according to claim 1, wherein said first coupling between the third body layer and the second body layer is made by providing a friction-enhancing fluid medium between the third body layer and the second body layer and, without introducing relative sliding there-between, pressing the second body layer against the third body layer such as to deform the second and third body layers into cold pressure welding contact with each other.

22. A method according to claim 1, wherein any of the first, second and third body layers is comprised of materials selected from the group consisting of metals, reinforced metal composites, and non-metal composites such as carbon composites.

23. A method according to claim 1, wherein either both of the first or second body layers are comprised of metal or one of said body layers is comprised of metal and the other comprised of a metal composite with a metal matrix.

24. A method according to claim 1, wherein the friction-enhancing fluid medium is selected from the group consisting of or CCl₄, a hydrocarbon solvent, or a siloxane such as hydrogendimethylsiloxane.

25. A method according to claim 1, wherein any of the first, second and third body layers has anisotropic structural properties.

26. A method according to claim 1, wherein any of the first, second, or third bodies are tubular in form.

27. A method according to claim 1, wherein the first body is comprised of an abutting arrangement of a first non-tubular body part with a second non-tubular body part and the coupling acts to couple together said first tubular body part to said second tubular body part.

28. A method according to claim 27, wherein the second body is tubular in form and the third body has hollow tubular or solid cylindrical form such as in combination to respectively define a hollow or solid coupling pin for locating and retaining the first and second non-tubular body parts in coupling relationship.

29. A coupling made by the method of claim 1.

30. A method according to claim 25, wherein said anisotropic properties result from the presence of reinforcement fibres, reinforcement whiskers, single crystal whiskers, or nano-particulates therein.

31. A method according to claim 2, wherein said first coupling between the third body layer and the second body layer is a low friction coupling.

32. A method according to claim 3, wherein said first coupling between the third body layer and the second body layer is a low friction coupling.

33. A method according to claim 2, wherein on pressing the second body layer against the first body layer neither body is subject to bulk plastic deformation thereof.
